(19) United States
(12) Patent Application Publication
(10) Pub. No.: US 2009/0122087 A1
(43) Pub. Date: May 14, 2009

(54) DISPLAY DEVICE

(76) Inventors: Junichi MARUYAMA, Yokohama (JP); Yoshihisa Ooishi, Yokohama (JP); Yuki Okada, Tama (JP); Takashi Shoji, Fujisawa (JP); Kikuo Ono, Mobara (JP); Ikuko Imajo, Mobara (JP); Masashi Baba, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/262,244

(22) Filed: Oct. 31, 2008

(30) Foreign Application Priority Data
Nov. 2, 2007 (JP) 2007-285719
Apr. 28, 2008 (JP) 2008-117061

(51) Int. Cl. G09G 5/10; G09G 3/36

(52) U.S. Cl. 345/690; 345/102

(57) ABSTRACT

There is provided a display device capable of delivering adequate video display performance even when a lighting period of a backlight is varied in accordance with the content or the like of image data. The device has circuits (8050, 8060) for varying a lighting period of a backlight (8090) for illuminating a display panel (8010) in accordance with image data (8002), setting information (8003), and the like from an external device; and circuits (8070, 8080) for adjusting the timing of start (and turning off) of lighting of the backlight in accordance with the length of the lighting period.

### CROSS-REFERENCE TO RELATED APPLICATION

The present application claims priority from Japanese applications JP 2007-285719 filed on Nov. 2, 2007 and JP 2008-117061 filed on Apr. 28, 2008, the content of which is hereby incorporated by reference into this application.

### BACKGROUND OF THE INVENTION

1. Field of the Invention

The present invention relates to a display device provided with a display panel for displaying an image by adjusting the transmissivity of light from a light source.

2. Description of the Related Art

Display devices can be largely classified into impulse-type display devices and hold-type display devices from the very viewpoint of characteristics of displaying moving images. An impulse-type display device is a device, such as a cathode-ray tube for example, in which the brightness of scanned pixels gets greater only within the period in which the pixels are being scanned, and in which the brightness is reduced immediately after scanning. A hold-type display device is a device, such as a liquid crystal display device, in which brightness based on the display data continues to be held until the subsequent scan.

A hold-type display device has an advantage in that good display quality can be obtained without flickering in the case of displaying a still image. On the contrary, in the case of displaying a moving image a phenomenon so-called moving image blur, which a periphery of a moving object seems blurry, occurs to result a significant reduction of the display quality.

FIGS. 1A and 1B are diagrams that show an example of moving image blur that occurs in a hold-type display device. In FIG. 1A, (a) is an example of an image pattern for evaluating moving image blur. Superimposed on a background having one gray level (e.g., white) is a rectangle having another gray level (e.g., black). The change in the gray level of the pattern shows a stepped pattern, as shown in (b) of FIG. 1A. The moving image blur can be evaluated by scrolling such an image pattern in the horizontal direction.

In FIG. 1B, (a) is an example of an image that is perceived when a person observes the image of the pattern described above displayed on a hold-type display device. The outline part of a rectangle that normally ought to have a sharp outline appears blurred in the manner shown in the diagram. The change in brightness perceived in this case shows smooth outline and gradually changed shape, as shown in (b) of FIG. 1B. The perceived brightness is normalized in the manner shown in (b) of FIG. 1B, and the width when the normalized perceived brightness changes from, e.g., 0.1 to 0.9 (or from 0.9 to 0.1) is referred to as moving image blur width and can be used as an index of moving image blur.

The occurrence of the moving image blur is caused by so-called retinal afterimage in which the visual sense of an observer integrally perceives the display before and after a movement on the display image in which the brightness is held, when the line of sight moves together with the movement of the object. Therefore, moving image blur cannot be completely solved no matter how much the response speed of the display device is improved.

Japanese Patent Application Laid-open No. 9-325715 proposes a method for solving such moving image blur in a hold-type display device in which the display characteristics of the display device are approximated to those of an impulse-type display device by switching on and off a shutter or a light source (backlight) provided to the display screen.

Further, related to a technology for intermittently lighting the backlight described above, Japanese Patent Application Laid-open No. 2004-62134 proposes a method which modulates peak brightness to attempt to improve display quality by varying the lighting period of the backlight synchronized with video display data or the like.

### SUMMARY OF THE INVENTION

In a display device that intermittently lights a backlight to perform display, a degree of occurrence of moving image blur increase and decrease depending on a period of time from writing a image data to switching on the backlight, when the lighting period is fixed to certain length. In other words, in the case that the lighting period has the length noted above, there is an optimal switching on timing for minimizing moving image blur. The optimal switching on timing varies depending on the length of the lighting period. Accordingly, there exists a problem that when the lighting period of the black light is varied in accordance with the content or the like of the video data, the backlight cannot be intermittently lighted with optimal switching on (or off) timing, and sufficient video display performance may not be obtained with fixed switching on (or off) timing.

In present invention, a circuit which increase and decrease the lighting period of the backlight in accordance with the content of the image data and setting information or the like from an external device, and a circuit for adjusting the timing of switching on (and off) the backlight in accordance with the length of above mentioned lighting period.

In accordance with the present invention, the display characteristics of an impulse-type display device can be produced and good display quality with little moving image blur can be obtained in a hold-type display device by intermittently lighting the backlight. Furthermore, in accordance with the present invention, a degree of occurrence of moving image blur can be constantly minimized and good display quality can be maintained regardless of the length of the lighting period of the backlight, even in cases in which the lighting period of the backlight is varied in accordance with the content of the image data or the like for the purpose of improving the contrast of an image as well as making other enhancements to image quality in the above mentioned display device.

In backlight intermittent lighting, the effect of improving moving image blur increases as the lighting period of the backlight is reduced. In other words, in accordance with the present invention, a highly convenient display device having a function for varying the lighting period of the backlight can be provided in which, e.g., an operation mode with the short lighting period of the backlight, dark screen and low moving image blur and an operation mode with long lighting period of the backlight, considerable moving image blur and bright screen instead are provided, and the operation modes can be selected in accordance with the preferences of the user of the display device.

### BRIEF DESCRIPTION OF THE DRAWINGS

These and other features, objects, and advantages of the present invention will become more apparent from the following description when taken in conjunction with the accompanying drawings wherein:

FIGS. 1A and 1B are diagrams showing examples of moving image blur that occurs in a hold-type display device;

FIG. 2 is a diagram showing a configuration example of a display panel and a backlight in a display device in which the present invention has been applied;

FIG. 3 is a diagram describing the basic principles of reducing moving image blur in driving the intermittent lighting of a backlight;

FIG. 4 is a diagram describing the effect that the lighting standby time has on moving image blur in driving the intermittent lighting of a backlight;

FIG. 5 is a diagram showing an example of the relationship between the optimal phase and the lighting ratio of the backlight in driving the intermittent lighting of a backlight;

FIG. 6 is an example of a timing chart showing the operation of a display device in which the present invention has been applied;

FIG. 7 is an example different from FIG. 6 of a timing chart showing the operation of a display device in which the present invention has been applied;

FIG. 8 is a block diagram of the display device of example 1 of the present invention;

FIG. 9 is a diagram showing a configuration example of the image characteristic extraction part in FIG. 8 for describing example 1 of the present invention;

FIG. 10 is a block example of the display device of example 2 of the present invention;

FIG. 11 is a timing chart showing an example of the backlight control signal in the display device of example 3 of the present invention;

FIG. 12 is a block diagram of the display device of example 3 of the present invention;

FIG. 13 is a block diagram of the display device of example 4 of the present invention;

FIG. 14 is a diagram describing the local light-modulation scheme of gradation reproduction in the display device of example 5 of the present invention;

FIG. 15 is a diagram describing the local light-modulation scheme with priority given to power consumption in the display device of example 5 of the present invention;

FIG. 16 is a diagram describing the concept of local light-modulation of the backlight in the display device of example 5 of the present invention;

FIG. 17 is an example of a timing chart showing the operation of a display device of example 5 of the present invention;

FIG. 18 is a block diagram of the display device of example 5 of the present invention;

FIG. 19 is an example of a timing chart showing a method for driving a backlight in the display device of example 5 of the present invention;

FIG. 20 is an example different from FIG. 19 of a timing chart showing a method for driving a backlight in the display device of example 5 of the present invention; and

FIG. 21 is an example different from FIGS. 19 and 20 of a timing chart showing a method for driving a backlight in the display device of example 5 of the present invention.

### DETAILED DESCRIPTION OF THE INVENTIONS

Preferred embodiments of the present invention are described below. First, the basic configuration and operation of the embodiments of the present invention will be described, and the specific details of the present invention will be described thereafter with reference to the diagrams of the examples.

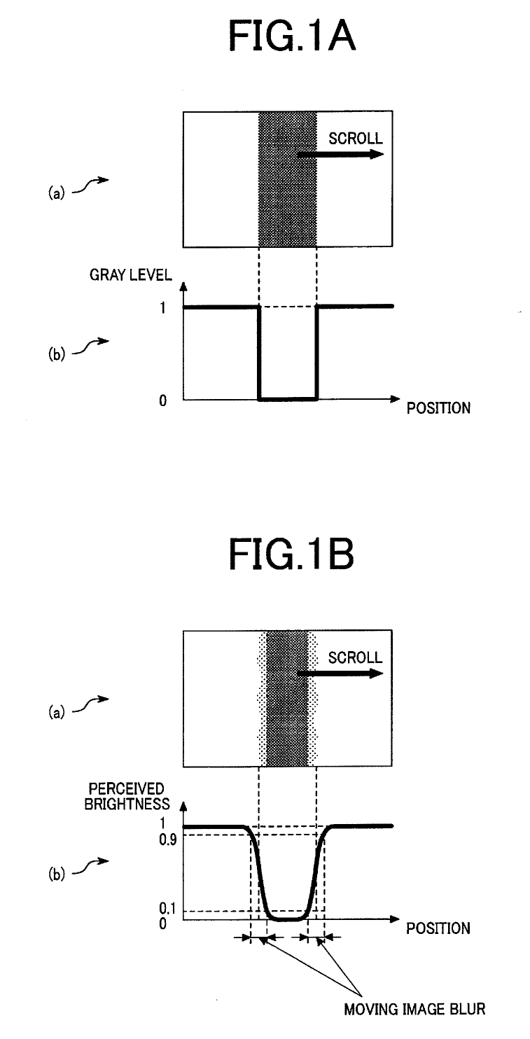

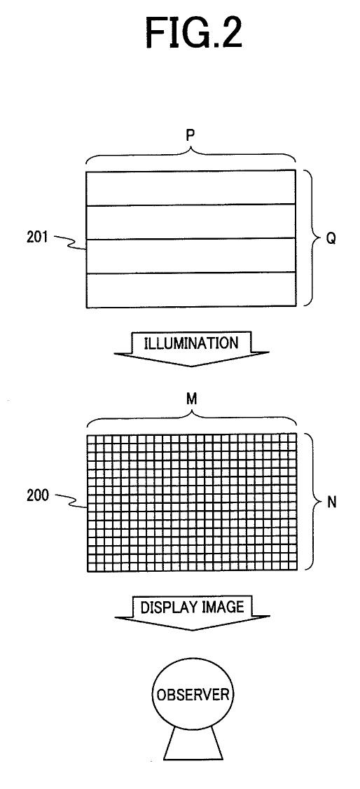

FIG. 2 is a diagram showing a configuration example of a display panel and a backlight in a display device in which an embodiment of the present invention has been applied. A display panel 200 is, e.g., a liquid crystal display panel, and the display elements of the M column and N row are arrayed as pixels (display units) in the form of a matrix and are configured (wherein M and N are each an integer of 1 or higher) so that each of the pixels can be individually controlled for transmissivity (modulation factor of the light that passes through the liquid crystal). A backlight 201 acts to illuminate the display panel 200, and examples of the backlight that may be used include a cold-cathode fluorescent lamp (CCFL), a hot-cathode fluorescent lamp (HCFL), and a light-emitting diode (LED). The backlight has at least one or more illumination areas arrayed in P columns and Q rows, and is configured so that the brightness, and the switching on and off timing can be controlled for each illumination area (wherein P and Q are each an integer of 1 or higher; and an example in which P=1 is shown in FIG. 1). The ultimate display brightness of each pixel of the display device is obtained by multiplying the transmissivity of each pixel of the display panel 200 and the brightness of each area of the backlight 201 that corresponds to the pixels. The display device presents to the observer an aggregate of the display brightness of each of the pixels as the display image of the display device.

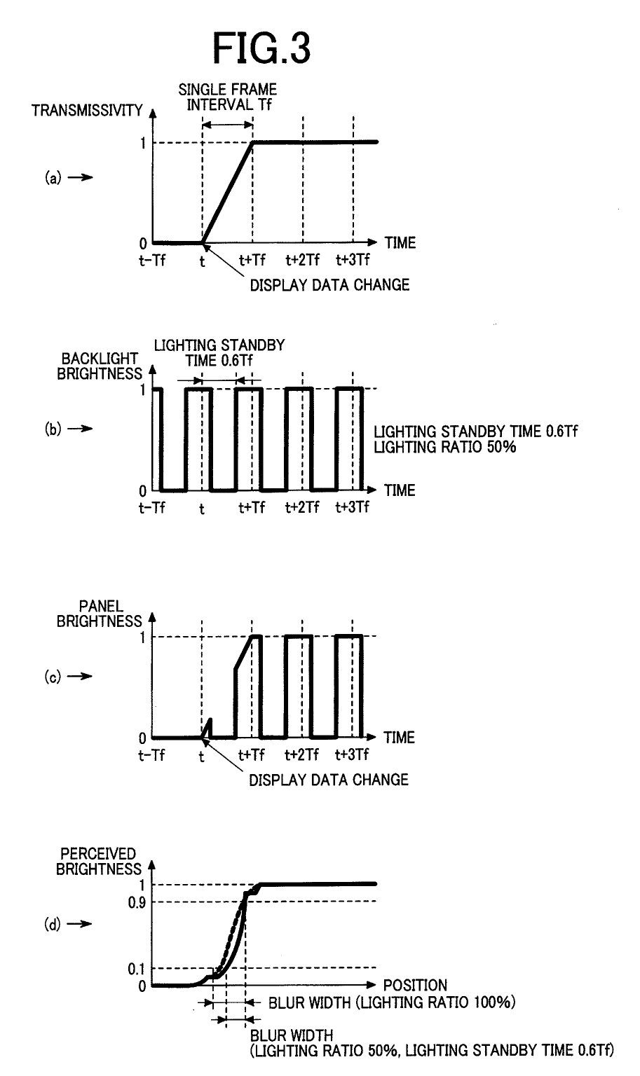

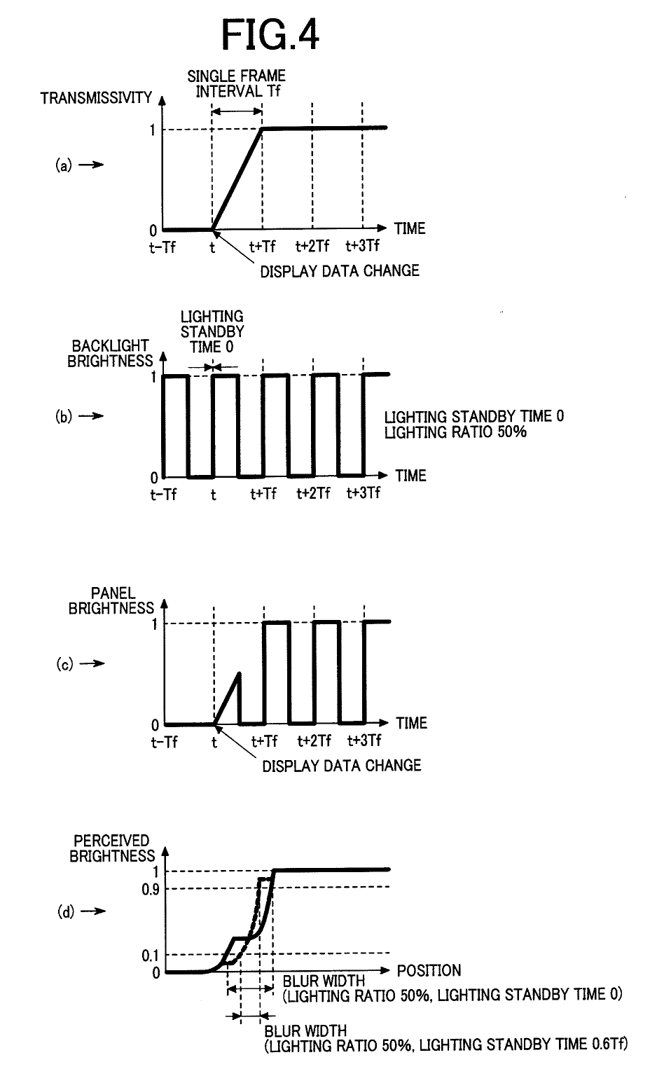

Next, the basic principles of reducing moving image blur in a display device in which an embodiment of the present invention has been applied will be described with reference to FIGS. 3 and 4. (a) in FIG. 3 is a diagram of an example of transmissivity response in the display elements constituting the display device. In (a), the time is represented on the horizontal axis and transmissivity is represented on the vertical axis. The transmissivity before and after the change in transmissivity by rewriting the display data is normalized and displayed as 0 and 1, respectively. The display device rewrites the display data of each display element at predetermined intervals. The rewrite interval is set to a single frame interval Tf. When the display panel is driven at, e.g., 60 Hz (the display data is rewritten 60 times per second), the single frame interval Tf is about 16.7 ms. The transmissivity is 0 until the time t in the response example shown in (a), and the display data changes at the time t, whereby the display element begins to respond, the transmissivity gradually changes, and the transmissivity becomes 1 at the time t+Tf.

(b) in FIG. 3 is a diagram showing an example of the change in brightness when the backlight for illuminating the display elements is intermittently lighted. In (b), time is represented on the horizontal axis and brightness of the backlight is represented on the vertical axis. In (b), the brightness of the backlight off and on is normalized to represent as 0 and 1 respectively. An example is shown in (b) in which the lighting standby time until data rewriting and lighting of the backlight is 0.6 Tf, and the lighting ratio is 50% (0.5 Tf). As used herein, the term “lighting ratio” is defined as Ton/Tf×100(%), wherein Ton is the period of time when the backlight is lighted on.

In the example of (b), on and off of the backlight is switched for each 0.5 Tf interval, which is half of a single frame interval Tf. In other words, the lighting ratio is 50%. In each frame, the backlight is lighted after 0.6 Tf has elapsed from the data rewrite time in each frame (i.e., the lighting standby time is 0.6 Tf). This is due to the fact that the backlight is lighted after waiting for the display element to sufficiently respond.

(c) is a diagram showing an example of the change in brightness of the display device in intermittent lighting of the backlight. In (c), time is represented on the horizontal axis, and panel brightness is represented on the vertical axis. The transmissivity before and after a change brought about by rewriting the display data is normalized to represent as 0 and 1 respectively. The change in brightness of the display device is obtained by multiplying the transmissivity of the panel display in (a) and the brightness of the backlight shown in (b).

(d) is a diagram showing an example of a change in brightness perceived by the observer's eye for the case in which an evaluation pattern such as that shown in (a) of FIG. 1A in a display device having response characteristics such as those of (c). The position on the panel is represented on the horizontal axis and the perceived brightness is represented on the vertical axis. The perceived brightness before and after a change in the transmissivity brought about by rewriting the display data is normalized to represent as 0 and 1 respectively. Characteristics such as those shown in (d) are calculated with consideration given to the integral effect of following line of sight, which is a human visual sensory characteristic. The integral effect of following line of sight, which is a human visual sensory characteristic, can be simulated by averaging movement in the range of a single frame interval for a waveform of the change in panel brightness such as (c).

In (d), the solid line shows an example of the case in which backlight intermittent lighting is driven at a lighting ratio of 50% and a standby time of 0.6 Tf, as shown in (c) The broken line shows an example of the case (lighting ratio: 100%) in which backlight intermittent lighting is not driven for comparison. It is apparent that carrying out backlight intermittent lighting driving reduces the width of moving image blur in comparison with the case in which backlight intermittent lighting driving is not carried out.

The state in which moving image blur has occurred and the effect of backlight intermittent lighting driving were described above with reference to FIG. 3.

Next, in backlight intermittent lighting driving, the effect that the timing for lighting the backlight (i.e., the lighting standby time) has on the magnitude of the moving image blur will be described with reference to FIG. 4. The example of FIG. 3 shows the case in which the lighting ratio is 50% and the lighting standby time is 0.6 Tf. In contrast, FIG. 4 shows an example of the case in which the lighting ratio is kept at 50%, but the lighting standby time is set to 0, as shown in (a) through (c). FIG. 4 is substantially the same as FIG. 3 except that the phase is different, so a description of each diagram is omitted. In (d), the solid line shows an example of the change in perceived brightness for the case in which the lighting standby time is set to 0. On the other hand, the broken line is an example in which the lighting standby time is set to 0.6 Tf in the same manner as (d) of FIG. 3. It is apparent that when the lighting standby time is set to 0, the moving image blur is increased in comparison with the case in which the lighting standby time is set to 0.6 Tf. In this manner, the lighting standby time of the backlight affects the magnitude of the moving image blur when the backlight is intermittently lighted.

Next, the relationship between the lighting ratio and the switching on timing of the backlight will be described in greater detail. Hereinbelow, the lighting standby time of the backlight will be referred to as the phase of the backlight in the display device of the present invention. As used herein, the phase is defined as Tl/Tv×100(%), wherein Tl is the time from the rewriting of the display data until the switching on of the backlight, and Tv is the valid data interval (described in greater detail below) of a single frame in a single frame interval.

As described above, the magnitude of the moving image blur is different depending on the phase of the backlight (i.e., corresponding to the lighting standby time) even if the lighting ratio of the backlight is constant. Conversely stated, a phase that minimizes moving image blur can be determined when the lighting ratio is at a certain value. Such a phase will be referred to as an “optimal phase.”

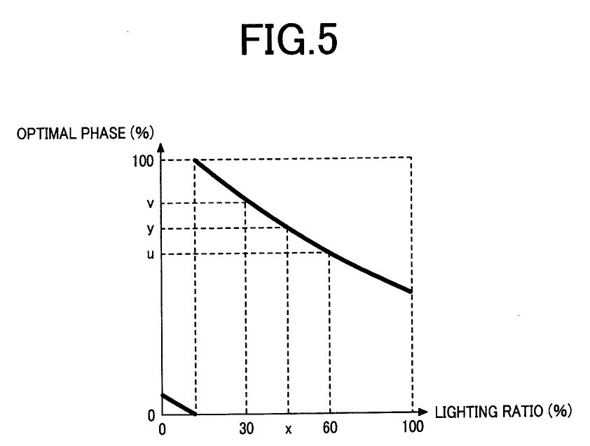

FIG. 5 is a diagram showing an example of the relationship between the lighting ratio of the backlight and the optimal phase. In FIG. 5, the lighting ratio is represented on the horizontal axis and the optimal phase is represented on the vertical axis. The example is one in which the phase that minimizes moving image blur is empirically or theoretically calculated as the optimal phase for each lighting ratio and is plotted to create a graph. With the aid of this graph, it is possible to obtain, for example, y as the optimal phase that minimizes moving image blur when the lighting ratio is set to x.

The optimal phase differs in accordance with the value of the lighting ratio of the backlight, as shown in FIG. 5. For example, u is the value of the optimal phase when the lighting ratio is 60%. In another example, v is the value of the optimal phase when the lighting ratio is 30%. u and v are not necessarily the same value. In other words, when the backlight is being driven with intermittent lighting, it is apparent that the phase of the backlight must be suitably controlled in accordance with the lighting ratio of the backlight in order to minimize the degree of occurrence of moving image blur and obtain the best moving image display quality.

The relationship between the lighting ratio of the backlight and the optimal phase in a display device to which the embodiment of the present invention has been applied was described above with reference to FIG. 5. The display device of the embodiment of the present invention is provided with a function for driving the intermittent lighting of the backlight with the aim of improving moving image blur, and good video display quality can be constantly obtained with little moving image blur by suitably adjusting the phase and constantly switching on the backlight at an optimal phase that corresponds to the lighting ratio, even when the lighting ratio is varied in accordance with the content or the like of the image data with the aim of improving the contrast or the like.

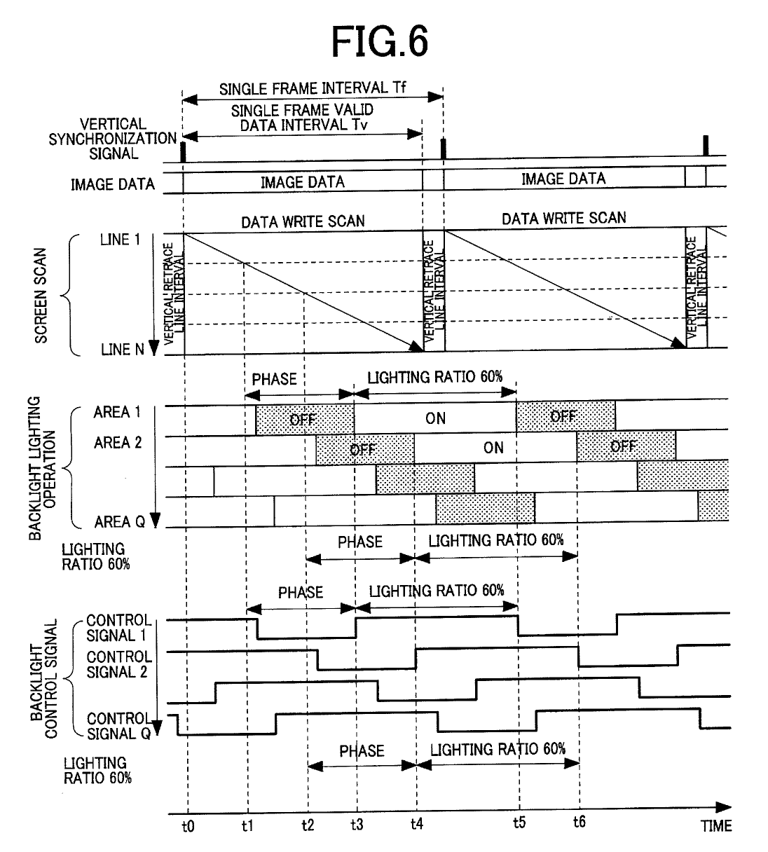

FIG. 6 is a timing chart for describing an operational example of a display device to which an embodiment of the present invention has been applied. In FIG. 6, the elapse of time is shown on the horizontal axis. FIG. 6 shows the temporal relationship between the “screen scan,” the “backlight lighting operation,” and the “backlight control signal” of the display panel in relation to the input signal of the display device. In the diagram, the vertical synchronization signal is a signal for specifying a single frame interval Tf of the image data. The image data is composed of chronologically aligned images of each frame. An interval (referred to as vertical retrace line interval) in which valid data is not present exists during each frame. A single frame valid data interval Tv is defined as the interval that does not include the vertical retrace line interval in a single frame interval (i.e., Tv≦Tf).

The “screen scan” portion of FIG. 6 shows the state of operation of the display panel when image data is displayed on the display device. Display data to be displayed to pixels is written to each of the pixels belonging to N rows of lines constituting the display panel is sequentially written from line 1 to line N. Generally, an interval that corresponds to the single frame valid data interval Tv is used for writing all the data of N lines. The “backlight lighting operation” shows the state of operation of each area of the backlight when the backlight is driven with intermittent lighting. Control is carried out by sequentially lighting and turning off an area having Q lines.

One area of the backlight is associated with at least one or more lines in the display panel (i.e., a single area of the backlight illuminates at least one or more lines of the display device). Provided that costs permit, a configuration is preferred in which the area of the backlight and the lines of the display panel are associated in a 1:1 relationship from the viewpoint of the display quality.

As described above, after the data of a line group of the display panel that corresponds to each area of the backlight has been written, the backlight is switched on after waiting a predetermined time until the display elements of the pixels of the line respond. In the example of FIG. 6, a frame starts at the time t0, and the display panel is sequentially scanned from line 1. The scan of the lines associated with area 1 of the backlight is completed at the time t1, and the scan of the lines associated with area 2 of the backlight is completed at the time t2. Scanning is thereafter continued in the same manner until line N is reached.

The backlight of area 1 is switched on at the time t3, which is the time specified by the phase that has elapsed since time t1, and is switched off at the time t5, which the time specified by the lighting ratio that has elapsed since time t3. Similarly, the backlight of area 2 is switched on at the time t4, which is the time specified by the phase that has elapsed since time t2, and is switched off at the time t6, which is the time specified by the lighting ratio that has elapsed since the time t4. Switching on and off operations are thereafter continued in the same manner until the area Q is reached.

The backlight control signal is a signal for controlling the switching on and off of each area of the backlight. In the example of FIG. 5, a configuration in which a PWM (Pulse Width Modulation) signal is used as the backlight control signal is shown as an example. Backlight control using a PWM signal can be carried out by using, e.g., a backlight control signal as a signal having two values, i.e., high and low, by configuring the backlight so as to be lighted when the signal value is high and to be turned off when the signal is low, and by adjusting each of the lengths (i.e., the temporal ratio of the two intervals) the interval in which the signal value is high and the interval in which the signal value is low.

In this case, it is preferred that Q number of backlight control signals embodied in a PWM signal be separately prepared, associated with each of the Q rows of backlight areas, and made to be capable of separately controlling each area. The method for implementing the backlight control signal is not particularly limited to PWM signals. Examples that may be used include a method for digitally providing the value of the phase, the lighting ratio, or the like to the backlight, and a method for measuring the control timing of the backlight and transmitting and providing the switching on command and off commands as commands to the backlight at a suitable time. Also, an analog control method that uses electric current values, voltage values, and the like may also be used.

An operational example of the case in which the backlight is driven with intermittent lighting in a display device in which the embodiment of the present invention is applied was described with reference to FIG. 6.

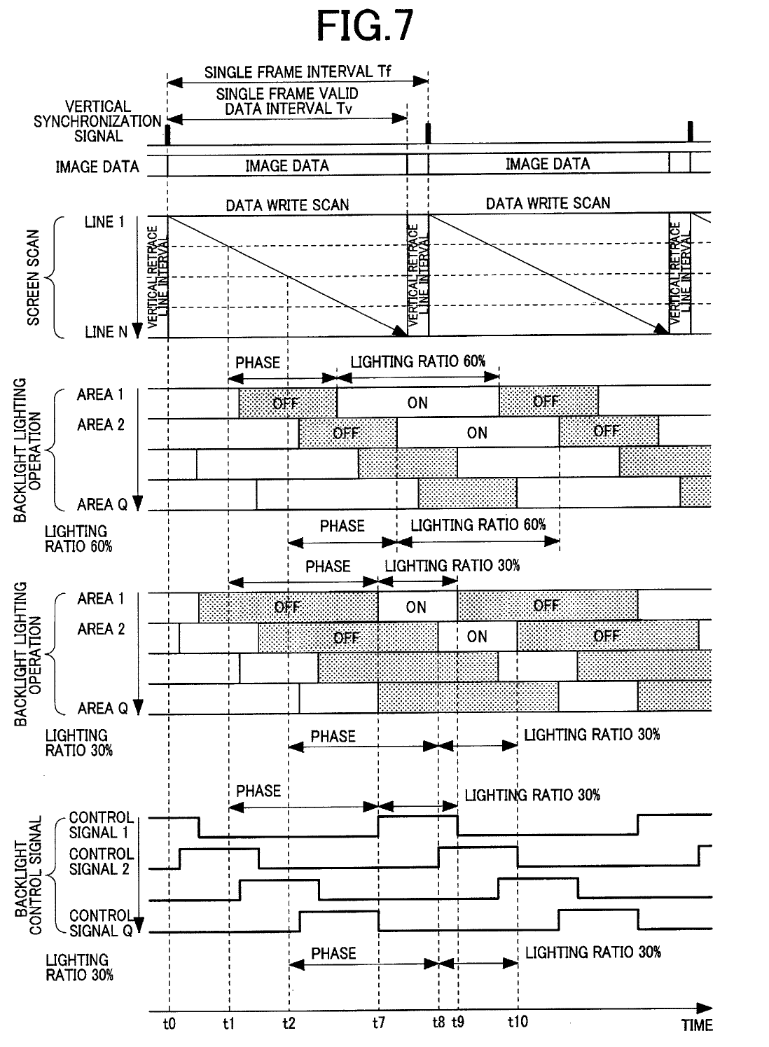

Next, the manner in which the display device in which an embodiment of the present invention has been applied changes the operation in accordance with the lighting ratio of the backlight will be described with reference to FIG. 7.

FIG. 7 is a timing chart for describing an operational example of a display device to which an embodiment of the present invention has been applied. In FIG. 7, the lighting ratio of the backlight is set to 30%. The point of difference is that the lighting ratio of the backlight is 60% in FIG. 6. The backlight lighting operation (corresponding to FIG. 6) for the case in which the lighting ratio is set to 60% is also shown for comparison. FIG. 7 is substantially the same as FIG. 6 except that the lighting ratio is different, so a description of each diagram is omitted.

In relation to the scanning of the display panel, the frame starts at time t0 and the display panel is sequentially scanned from line 1 in the example in which the lighting ratio is 30%, in the same manner as the example in which the lighting ratio is 60%. The scanning of a line that corresponds to area 1 of the backlight is completed at the time t1, and the scanning of a line that corresponds to area 2 of the backlight is completed at the time t2. Scanning is thereafter continued in the same manner until line N is reached.

The backlight of area 1 is switched on at the time t7, which is the time specified by the phase that has elapsed since the time t1, and is switched off at the time t9, which is the time specified by the lighting ratio that has elapsed since the time t7. Similarly, the backlight of area 2 is switched on at the time t8, which is the time specified by the phase that has elapsed since the time t2, and is switched off lighting at the time t10, which is the time specified by the lighting ratio that has elapsed since time t8. Switching on and off operations are thereafter continued in the same manner until area Q is reached.

In this case, the time t7 and the time t8, which are the switching on times of the area 1 and area 2 of the backlight, are calculated in relation to the optimal phases that correspond to the lighting ratios, as shown in FIG. 5. Consequently, the time t7 shown in FIG. 7 does not necessarily match the time t3 shown in FIG. 6. Also, the time t8 shown in FIG. 7 does not necessarily match the time t4 shown in FIG. 6. The same applies to other areas.

In relation to the switching off time of the areas 1 and 2 of the backlight as well, t9 and t10 in FIG. 7 and t5 and t6 in FIG. 6 do not necessarily match. The same applies to other areas as well.

In this manner, the switching on or off time of the backlight is fixed in a conventional display device, but in the display device of the embodiments of the present invention, moving image blur can be constantly minimized and good video display quality can be obtained by adjusting the phase of the backlight in accordance with the lighting ratio.

The relationship between the lighting ratio, the phase, and the moving image blur in the driving of the backlight with intermittent lighting was described above. Also described was a method for driving a backlight so that moving image blur can be minimized by suitably controlling the phase in accordance with the lighting ratio, which is a feature of the display device of the embodiments of the present invention.

Described next are examples of the display device of the embodiments of the present invention that make it possible to implement the method for driving the backlight.

### EXAMPLE 1

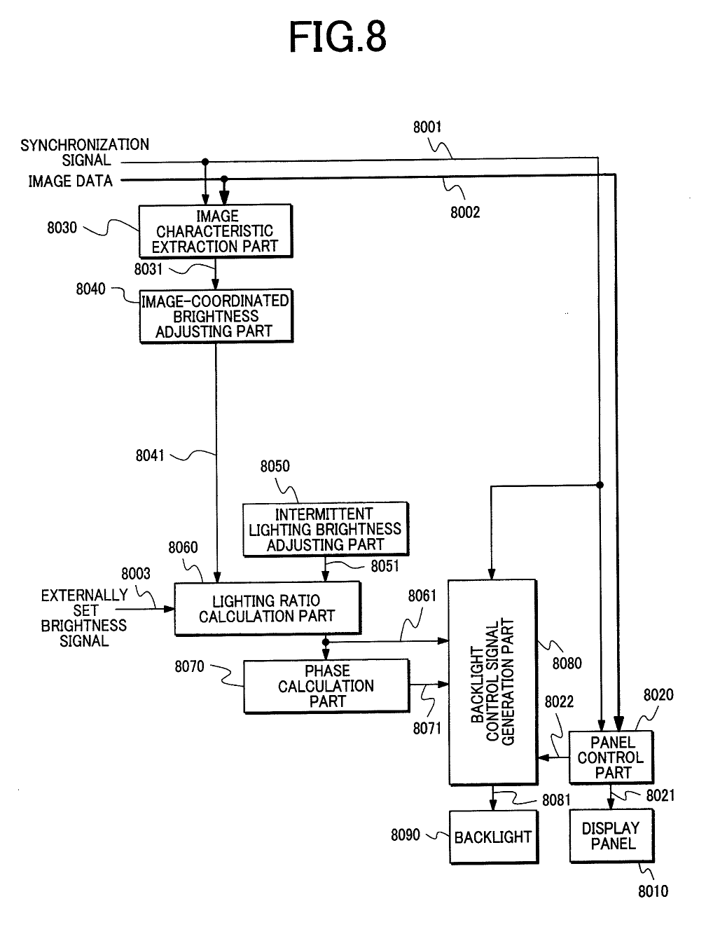

FIG. 8 is a block diagram of a display device for describing example 1 of the present invention. The display device is, e.g., a display device for a TV receiver, a PC (personal computer), mobile phone, and other information apparatuses, and is a typical liquid crystal display device provided with a function for receiving and displaying various image data as input.

The display device is composed of a display panel 8010, a panel control part 8020, an image characteristic extraction part 8030, an image-coordinated brightness adjusting part 8040, an intermittent lighting brightness adjustment part 8050, a lighting ratio calculation part 8060, a phase calculating part 8070, a backlight control signal generation part 8080, and a backlight 8090. The display device receives a synchronization signal 8001 and image data 8002 as input from an external device (not shown). The synchronization signal 8001 is composed of, e.g., a vertical synchronization signal for specifying a single frame interval (interval for displaying a single screen) of the image data 8002, a horizontal synchronization signal for specifying a single horizontal scan interval (interval for displaying a single line), a data valid interval signal for specifying a valid interval of the image data, and a reference clock signal synchronized with the image data, as well as other data.

The display panel 8010 is provided with a function for displaying an image that corresponds to the inputted data. The display panel 8010 can be applied to a liquid crystal display panel for displaying an image by controlling for each pixel the transmitted light from the backlight 8090, wherein the liquid crystal display elements as pixels that allow the transmissivity to be individually controlled are arrayed in the form of a matrix of M columns×N rows.

The panel control part 8020 receives the synchronization signal 8001 and the image data 8002 as input, generates from the signals various panel control signals 8021 for controlling the display panel 8010, and is provided with a function for performing control so that the display panel 8010 performs suitable display. The image characteristic extraction part 8030 receives the synchronization signal 8001 and the image data 8002 as input, and is provided with a function for extracting various characteristic values 8031 of the image data 8002.

Examples of the various characteristic values 8031 include the maximum brightness (gray level) of each frame, minimum brightness (gray level), average brightness (gray level), frequency distribution (histogram) of the brightness (gray level), spatial distribution of the brightness (gray level), color shading, presence of movement, and the magnitude of movement.

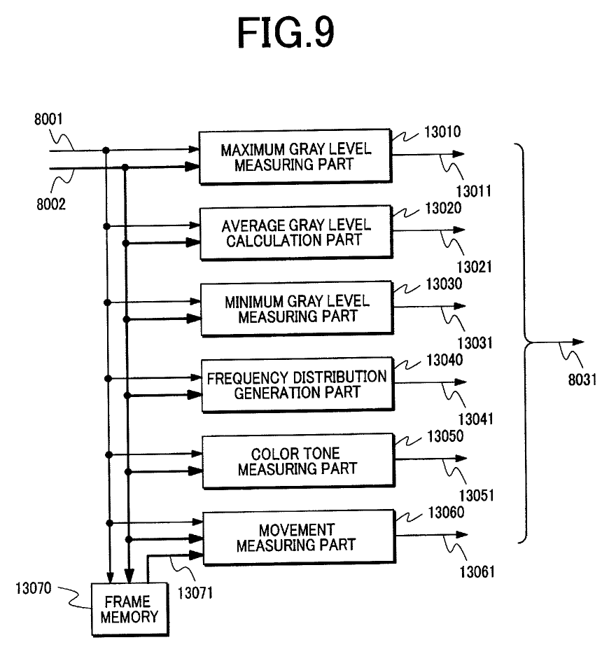

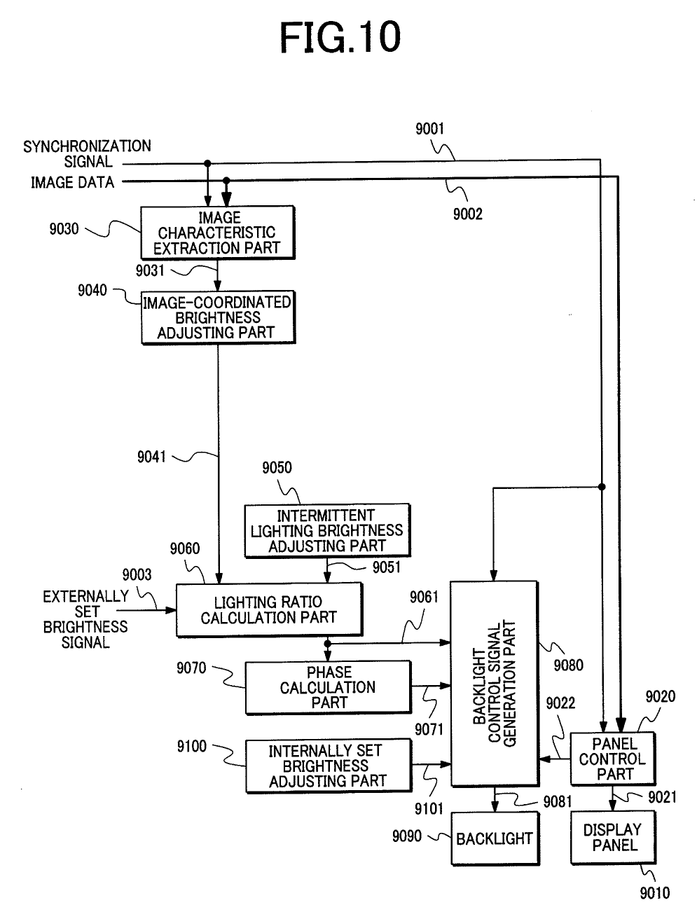

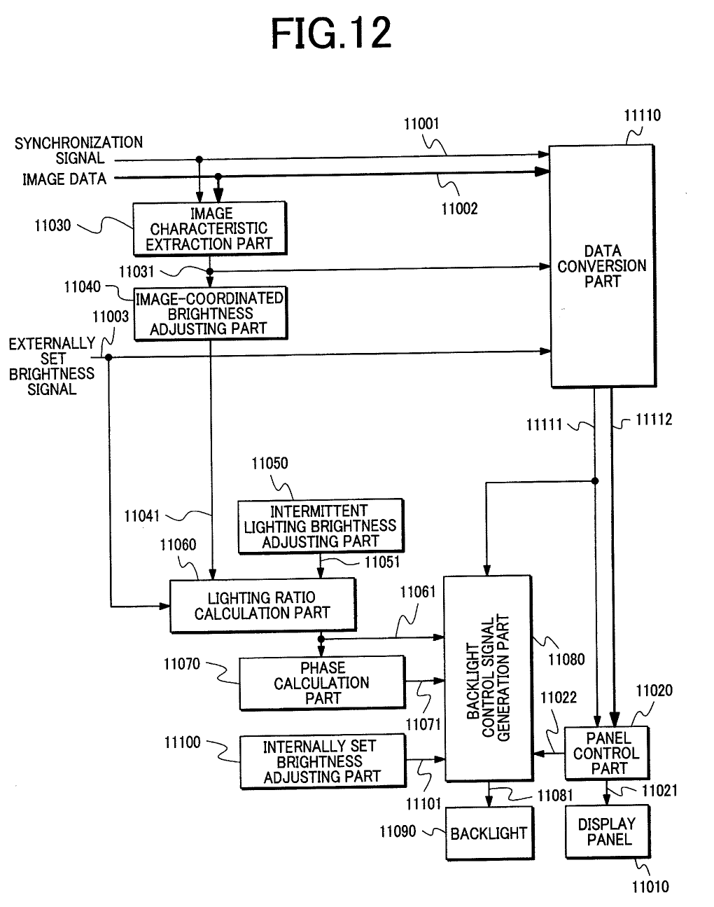

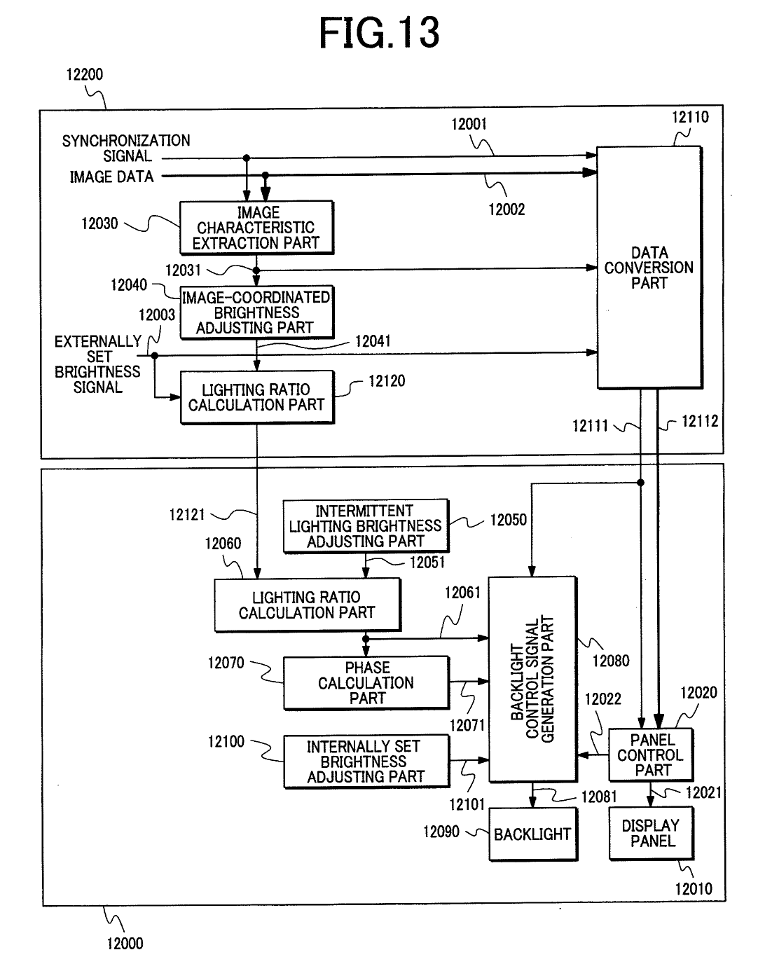

FIG. 9 is a diagram showing a configuration example of the image characteristic extraction part 8030 in FIG. 8 for describing example 1 of the present invention. The configuration of the image characteristic extraction part is the same in later-described FIG. 10 for describing the configuration of example 2, FIG. 12 for describing the configuration of example 3, and FIG. 13 for describing the configuration of example 4. Therefore, a redundant description is not provided in each example described below. In FIG. 9, the image characteristic extraction part 8030 is provided with, e.g., a maximum gray level measuring part 13010, an average gray level calculating part 13020, a minimum gray level measuring part 13030, a frequency distribution generation part 13040, a color tone measuring part 13050, a movement measuring part 13060, and a frame memory 13070.

The maximum gray level measuring part 13010 measures the maximum value of the gray level included in each frame of the image data 8002, and outputs the maximum value as the maximum gray level value 13011. The average gray level calculating part 13020 calculates the average value of the gray level included in each frame of the image data 8002 and outputs the average value as the average gray level value 13021. The minimum gray level measuring part 13030 measures the minimum value of the gray level included in each frame of the image data 8002, and outputs the minimum value as the minimum gray level value 13031.

The frequency distribution generation part 13040 determines the number of pixels included in each frame for each gray level of the image data 8002, and outputs the number of pixels as a frequency distribution (histogram) 13041. The color tone measuring part 13050 measures the color tone of each frame and outputs the color tone as color tone information 13051. Color tone information is an index that expresses the characteristics of an image, e.g., whether the image has a reddish hue and whether the image is a greenish image. The color tone information can be calculated using a technique in which a histogram is generated for each color, e.g., RGB, and the balance of each RGB color is calculated based on the histogram. The frame memory 13070 holds the image data 8002 for a specific time, e.g., the length of a single frame as a delay and outputs the data. For example, reference numeral 13071 is the image data of a single frame prior.

The movement measuring part 13060 compares image data 8002 and the image data 13071 of a single frame prior, and outputs the existence of movement and the magnitude of the movement as movement information 13061. The image characteristic extraction part 8030 may be provided with only a portion of such information, and may be provided with a function for extracting the other characteristics of the image data. The various characteristic values 8031 include the maximum gray level value 13011, the average gray level value 13021, the minimum gray level value 13031, the frequency distribution 13041, the color tone information 13051, the movement information 13061, and the like.

A configuration is also possible in which the screen is divided into small areas and the various characteristic values are extracted for each of the small areas, rather than determining the various characteristic values in the entire screen. The two-dimensional characteristics (for example, distribution of the brightness such as the upper portion of the screen being bright, and the screen gradually becoming darker in progress toward the lower part of the screen, and other characteristics) of the image data can be conveniently obtained by using such a configuration. Such two-dimensional characteristics can be used to control (in the example above, the brightness of the backlight area of the upper portion of the screen is increased and the brightness of the backlight area of the lower portion of the screen is reduced) the brightness of the corresponding backlight area in greater detail, and is valuable information for improving quality and reducing power consumption. The synchronization signal 8001 is used for identifying each frame break and determining the position on the screen in the calculation of each characteristic value.

The image-coordinated brightness adjusting part 8040 calculates the lighting ratio 8041 for adjusting the image-coordinated brightness that is used for adjusting the brightness of the backlight 8090 in accordance with the image from the characteristic value 8031 extracted in the image characteristic extraction part 8030. For example, the average brightness of an image can be used as a characteristic value 8031 for adjusting the brightness of the backlight. For example, a technique can be adopted in which the contrast of the display image is improved and good quality is obtained by, e.g., reducing the brightness of the backlight in an image frame having a high average brightness (i.e., bright) and increasing the brightness of the backlight 8090 in an image frame having a low average brightness (i.e., dark). Naturally, characteristics other than the average brightness may be used for calculating the lighting ratio 8041 and a plurality of characteristics may be used in combination.

The intermittent lighting brightness adjustment part 8050 calculates the brightness that will be used as a reference when driving the backlight 8090 with intermittent lighting, and outputs the lighting ratio 8051 for backlight intermittent lighting. An externally set brightness signal 8003 is inputted from an external device (not shown) and is the brightness information of the display device set by an external device. For example, a configuration can be envisioned in which a user can select the level of brightness of the display device in accordance with a preference in order to improve the convenience for the user. In the case that a display device has been configured in the manner described above, the brightness level selected by the user corresponds to the externally set brightness signal 8003. The externally set brightness signal 8003 can be configured in the display device so as to be reflected in the brightness adjustment of the backlight 8090, whereby the function described above can be implemented. More specifically, the externally set brightness signal 8003 can be included in the calculation of a combined lighting ratio 8061 in the lighting ratio calculation part 8060.

Alternatively, a light sensor is provided for determining the brightness of the ambient environment in which the display device is disposed, and a configuration can be envisioned in which the brightness level of the display device is automatically controlled so as to facilitate user viewing on the basis of the ambient brightness obtained by the light sensor. In the case in which a display device is configured in the manner described above, the ambient brightness information obtained by the light sensor corresponds to the externally set brightness signal 8003. The externally set brightness signal 8003 can be configured in the display device so as to be reflected in the brightness adjustment of the backlight 8090, whereby the function described above can be implemented. More specifically, the externally set brightness signal 8003 can be included in the calculation of a combined lighting ratio 8061 in the lighting ratio calculation part 8060.

The lighting ratio calculation part 8060 comprehensively calculates the brightness required by the backlight 8090 from the lighting ratio 8041 for adjusting the image-coordinated brightness, the lighting ratio 8051 for driving the backlight with intermittent lighting, and the externally set brightness signal 8003, and calculates a combined lighting ratio 8061 for lighting the backlight 8090 in order to obtain the comprehensively calculated brightness. More specifically, the lighting ratio for the external setting is calculated from the externally set brightness signal 8003, for example, after which it is possible to used as the combined lighting ratio 8061 the result of multiplying all the lighting ratios, i.e., the lighting ratio 8041 for image-coordinated brightness adjustment, the lighting ratio 8051 for driving the backlight with intermittent lighting, and the lighting ratio for external setting.

The phase calculating part 8070 calculates the optimal phase 8071 of the backlight 8090 from the combined lighting ratio 8061 and outputs it. Characteristics information such as that shown as an example in FIG. 5 is used for calculating the optimal phase 8071.

The phase calculating part 8070 can be configured specifically to obtain the optimal phase 8071 by preparing the characteristics of the relationship between the lighting ratio and the optimal phase shown in FIG. 5 as a lookup table, for example, and referring to the lookup table in relation to the combined lighting ratio 8061 calculated in the lighting ratio calculation part 8060. Alternatively, the phase calculating part 8070 may be configured to obtain the optimal phase 8071 in relation to the combined lighting ratio 8061 by preparing the characteristics of the relationship between the lighting ratio and the optimal phase as an approximate function of the lighting ratio, and calculating the function formula.

The backlight control signal generation part 8080 generates a backlight control signal 8081 for each area of the backlight 8090 from the synchronization signal 8001, the combined lighting ratio 8061, the optimal phase 8071, and write line information 8022, and outputs the signal. The write line information 8022 is, e.g., a counter value or the like for determining to which line the lines of the display panel 8010 have been written.

The backlight control signal generation part 8080 estimates the timing of writing to certain line of the display panel 8010 on the basis of the write line information 8022, generates a control signal 8081 that switches on the backlight area after having waited the time specified by the optimal phase 8071 from the time at which the writing of the line belonging to a certain backlight area has ended, and outputs the signal. The backlight area is lighted for the time specified by the combined lighting ratio 8061, and generates and outputs a control signal 8081 that switches off the backlight area. The driving of the backlight 8090 with intermittent lighting can be implemented by individually carrying out for each backlight area a series of processes composed of display data writing, standby, switching on, and switching off.

The backlight 8090 is provided with a function for illuminating the display panel. As described above, examples of the backlight that may be used include a cold-cathode fluorescent lamp (CCFL), a hot-cathode fluorescent lamp (HCFL), and a light-emitting diode (LED).

Example 1 of the display device in which the present invention has been applied was described above with reference to FIG. 8. A backlight can be driven with intermittent lighting as shown in FIG. 4, and good picture quality with reduced moving image blur can be obtained by configuring the display device in the manner described above.

### EXAMPLE 2

The configuration of the display device of example 2 of the present invention will be described next with reference to FIGS. 9 and 10.

FIG. 10 is a configuration example of the display device of example 2 of the present invention. The display device of example 2 has the configuration of example 1 shown in FIG. 8 and is additionally provided with an internally set brightness adjustment signal 9100. Other points are substantially the same as the configuration shown in FIG. 8, and a description is therefore omitted. In FIG. 9, the internally set brightness adjustment signal 9100 outputs internally set brightness adjustment information 9101 for adjusting the brightness specified in advance inside the display device. For example, a polychromatic light source other than a white light source can be used as a backlight 9090. For example, when the light source of the backlight 9090 is an LED, an LED having three primary colors red, green, and blue can be used in place of using a white LED. The use of such a polychromatic light source has an advantage in that the color range that can be displayed can be improved in comparison with the case in which a white light source is used. However, the light of an LED having three colors must be mixed in order to emit a white color using an LED having three colors. In this case, the white color tone (color temperature) obtained by mixing the light of three colors fluctuates depending on the intensity of each color.

In other words, the emission intensity of the red, green, and blue LEDs must be individually adjusted for each color in order to obtain a desired color temperature. For example, control is required so that the emission intensity of red, green, and blue is 3:2:1. It is the internally set brightness adjustment signal 9100 that is used to implement schemes such as the color temperature adjustment.

The lighting ratio must be made to be different for each color in order to implement an internally set brightness as described above using a control signal embodied in the PWM scheme. In this case, the internally set brightness adjustment information 9101 is the lighting ratio of each of the colors. The method for adding such control in the simplest manner in the configuration example shown in FIG. 8 is to, first, adopt a configuration in which the combined lighting ratio 8061 is prepared for each color; the lighting ratio for each color for adjusting the internally set brightness calculated in an internally set brightness adjustment part is inputted to the lighting ratio calculation part 8060 in a configuration that allows independent calculation; and all the lighting ratios, i.e., the lighting ratio 8041 for the image-coordinated brightness adjustment, the lighting ratio 8051 for driving the backlight with intermittent lighting, the lighting ratio for external setting, and the lighting ratio for each color for adjusting the internally set brightness are multiplied when the combined lighting ratio 8061 is calculated for each color. The backlight 8090 is then driven with intermittent lighting for each color.

However, there is a problem in a configuration such as that described above. The problem is that there are cases in which the intermittent lighting ratio of the backlight 8090 may be different for each color because a scheme is adopted in which the combined lighting ratio is calculated and separately controlled for each color. A different intermittent lighting ratio for each color of the backlight 8090 leads to a result in which the width of the moving image blur is different for each color. A different moving image blur width for each color causes a phenomenon in which false colors that were not originally expected to be in the image data are perceived in the outline parts of moving display objects when, e.g., an image pattern such as that in FIG. 1 is displayed, leading to a degradation in quality.

In order to avoid problems such as those described above, it is preferred that a configuration be adopted in which the lighting ratio for adjusting the internally set brightness, which is used for adjusting the color of a polychromatic light source, is made to be independent from the lighting ratio calculation part 8060 so that the calculation of the combined lighting ratio 8061 is unaffected, as shown in FIG. 10.

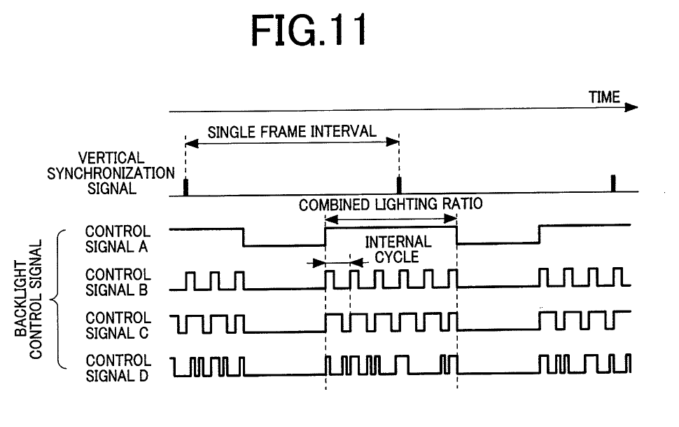

An example of a method for implementing the internally set brightness adjustment is described next. FIG. 11 is a timing chart showing an example of the backlight control signal 9081 for adjusting the internally set brightness shown in the configuration example shown in FIG. 10. In FIG. 11, an example is shown in which the backlight control signal is implemented using a PWM scheme.

A control signal A is an example of the internally set brightness adjustment being set to 100%. Lighting is carried out for the entire period specified by the combined lighting ratio. A control signal B is an example of the internally set brightness adjustment being set to 30%. The configuration is one in which the period specified by the combined lighting ratio is further divided into a plurality of periods and switching on and off is repeated in units of the small periods (the small periods are referred to as the internal cycle) thus divided. The ratio of the lighting periods occupying the internal cycle is set to be 30%.

When the backlight control signal 9081 is configured in the manner described above, a problem such as the false colors described above does not occur. This is due to the fact that human visual perception cannot perceive blinking carried out in very small increments of time such as that of the internal cycle, and it is perceived that during the period specified by the combined lighting ratio that continuous emission has occurred. In this case, the magnitude of the moving image blur does not change when the internally set brightness adjustment is set to 100%. In other words, the internally set brightness adjustment is not affected by the magnitude of the moving image blur, and false colors are not generated. On the other hand, even if the blinking of the internal cycle cannot be perceived, the total amount of light incident on the retina is reduced. Therefore, the perceived brightness is reduced and the demands of brightness adjustment can be satisfied.

A control signal C is an example of the internally set brightness adjustment being set to 60%. The signal can be implemented by setting the ratio of the lighting periods occupying the internal cycle to be 60% in the same manner as the control signal B. A control signal D is an example separate from control signal B of the case in which the internally set brightness adjustment is set to 30%. The switching on and off is not repeated using a specific cycle as a reference, and the signal is implemented by controlling the ratio of the lighting periods occupying the period specified by the combined lighting ratio is brought to 30% while randomly switching on and off the backlight.

Such control can provide an expectation of obtaining an effect of preventing each backlight area to be switched on and off together simultaneously, dispersing the times at which electric current flows, and preventing a large amount of electric current from momentarily flowing to the circuit, as well as an effect in which the frequency spectrum of electromagnetic noise is dispersed.

The configuration of example 2 of the display device to which the present invention has been applied was described above with reference to FIGS. 10 and 11.

### EXAMPLE 3

The configuration of the display device of example 3 of the present invention will be described next with reference to FIG. 12.

FIG. 12 is a block diagram of the display device of example 3 of the present invention. Example 3 has a data conversion part 11110 additionally provided to the configuration example shown in FIG. 10, and is different on the point of having a configuration in which an externally set brightness signal 11003 is inputted to the data conversion part 11110 in addition to the lighting ratio calculation part 11060. Other points are substantially the same as the configuration shown in FIG. 10 and a description is therefore omitted.

The data conversion part 11110 is provided with a function for performing various data conversions on the image data 11002 on the basis of the externally set brightness signal 11003 and the characteristic value 11031 of the image data extracted by the image characteristic extraction part 11030. Reference numeral 11112 shows the data-converted image data, and reference numeral 11111 shows a synchronization signal synchronized with the data-converted image data.

An example of the data conversion is a data conversion method that is used for reducing power consumption. Following is an example of the operation of the data conversion method. When a certain brightness B1 is to be displayed in the display device, the relationship B1=B11×Tr1 holds true when the backlight is at a brightness B11 in the reference state and the display panel is at a transmissivity Tr1.

In contrast, in the data conversion method, the lighting ratio of the backlight 11090 is reduced to less than that of the reference state and the backlight brightness B12 is reduced (B11>B12). On the other hand, the display data is converted so that the transmissivity Tr2 of the display panel is made to be greater than normal (Tr1<Tr2). The brightness observed in this case is B2=B12×Tr2. Here, the same brightness as the reference brightness can be achieved (i.e., B1=B2) by suitably adjusting the backlight brightness B12 and the transmissivity Tr2.

In the process, the image-coordinated brightness adjusting part 11040 adjusts the backlight brightness B12 using the characteristic value 11031 of the image data. Also, the data conversion part 11110 converts the image data 11002 so as to obtain a suitable transmissivity Tr2 using the characteristic value 11031 of the image data.

In the method, since the brightness of the backlight 11090 can be reduced in comparison with the reference state in the manner described above, the power consumption of the backlight can be considerably reduced and the power-saving effect of the display device is high. Alternatively, it is possible to adopt a method in which not only is the brightness of the backlight 11090 adjusted in accordance with the ambient brightness information obtained by the light sensor, but the image data 11002 is also converted so as to obtain a more easily viewable display, in the case of a configuration in which a light sensor for determining the ambient brightness of the display device is provided, the ambient brightness information obtained by the light sensor is used as the externally set brightness signal 8003, and the brightness level of the display device is automatically controlled so as to be easily viewed by the user, as described in the FIG. 8, for example.

The configuration of example 3 of the display device to which the present invention has been applied was described above with reference to FIG. 12.

### EXAMPLE 4

The configuration of the display device of example 4 of the present invention will be described next with reference to FIG. 13.

In general, processing for extracting a characteristic value from the image data and processing for converting the image data is complicated and considerable cost is incurred to carry out such processing. Accordingly, the addition of the characteristics extraction processing or the like to the display device leads to considerably higher costs in a display device composed of a minimum number of components such as, e.g., a display panel and a backlight. In view of the above, a method for configuring a display device that reduces cost increases while applying the backlight intermittent lighting driving of the embodiments of the present invention will be described below.

FIG. 13 is a block diagram of the display device of example 4 of the present invention. Example 4 is divided into a signal-processing device 12200 and a display device 12000 on the basis of the configuration example shown in FIG. 12, and is an example in which a portion of the functions provided to the display device in FIG. 12 is moved to the signal-processing device 12200. The display device 12000 receives as input from the signal-processing device 12200 a combined lighting ratio 12121, image data 12112 converted in the data conversion part, and a synchronization signal 12111 synchronized with the image data.

The signal-processing device 12200 is provided with a function (not shown) for subjecting the image data 12002 to various signal processing. Examples of various signal processing includes color tone adjustment processing, enlarging and shrinking processing, interlace/progressive conversion processing, OSD (on-screen display) processing, and various other image signal processing, and such processing is already generally incorporated in television receivers, mobile phones, and other information terminals. Also, the signal-processing device 12200 for performing the above processing often already has a function for extracting the image characteristic as described above, as well as other functions.

In other words, the cost of a display system can be made relatively lower than a configuration in which the same functions are completely newly added to the display device, by adopting a configuration in which image characteristic extraction and data conversion processing are carried out in a signal-processing device described above. In other words, the signal-processing device 12200 is configured so as to be composed of an image characteristic extraction part 12030, an image-coordinated brightness adjusting part 12040, a lighting ratio calculation part 12120, and a data conversion part 12110.

The lighting ratio calculation part 12120 calculates the brightness required by the backlight 12090 of the display device 12000 from the externally set brightness signal 12003 and the lighting ratio 12041 for adjusting the image-coordinated brightness, and calculates the combined lighting ratio 12121 to be used in lighting the backlight 12090 in order to obtain the brightness. In this case, the signal-processing device 12200 is not required to monitor the backlight intermittent lighting driving because the driving is a function carried out under the management of the display device 12000. Accordingly, the lighting ratio 12051 for driving the backlight with intermittent lighting is not required to be incorporated into the calculation of the combined lighting ratio 12121. On the other hand, the lighting ratio calculation part 12060 provided to the display device 12000 calculates the ultimate combined lighting ratio 12061 from the combined lighting ratio 12121 inputted from the signal-processing device 12200, and the lighting ratio 12051 for driving the backlight with intermittent lighting.

In this case, it is possible to use a digital format in which the numerical values are digitally expressed, a PWM format as described above, an analog scheme in which voltage values and electric current values are used, or another format as the signal format of the combined lighting ratio 12121 inputted to the display device 12000.

Other points are substantially the same as the configuration shown in FIG. 12 and a description is therefore omitted. The display device 12000 can be provided at low cost by configuring the device in the manner shown in FIG. 12.

A configuration example of the display device to which the present invention is applied was described above with reference to FIG. 13.

In accordance with the display device of the examples of the present invention as described above, the function for driving the backlight with intermittent lighting having the aim of improving moving image blur is provided, and good video display quality can be constantly obtained with little moving image blur by suitably adjusting the phase and constantly lighting the backlight in an optimal phase that corresponds to the lighting ratio, even when the lighting ratio is made to fluctuate in accordance with the content or the like of the image data with the aim of improving the contrast as well as other purposes.

### EXAMPLE 5

A fifth example of the present invention will be described next. Mainly described in the examples described above is a method for achieving intermittent lighting control in a display device provided with a backlight divided into a plurality of areas. In the present example, a method will be described for implementing a display device in which local light-modulation control is combined with the intermittent lighting control.

As used herein, the term “local light-modulation control” is referred to as a technique for individually controlling the brightness of each area of the backlight in accordance with the characteristics of the input image data, in the display device of the embodiments of the present invention provided with a backlight in which the brightness can be controlled for each area, the backlight being divided into a plurality of areas.

For example, the maximum gray level of an entire single screen of the input image data can be used as the characteristic. When high gray level is not included in the input image data, for example, the backlight is not required to be maximally lighted, and the brightness of the backlight can be reduced (light-modulated) to a level at which a necessary and sufficient amount of light is obtained. Reducing the brightness of the backlight has the effect of allowing power consumption to be reduced by an equivalent amount. In other words, power consumption can be reduced when the maximum value of gray level included in the input image data for a single entire screen is less than the maximum value of gray level that can be displayed on the display device. In this case, the extent of the reduction in power consumption depends on the maximum gray level of the input image data for a single entire screen. The effect of reduced power consumption is enhanced as the maximum gray level of a single entire screen is reduced.

Hereinbelow in the present specification, the scheme for controlling the brightness of the backlight by using the characteristics of the input image data for a single entire screen will be referred to as “overall light-modulation.”

The concept of overall light-modulation can be expanded, the backlight can be divided into a plurality of areas, and control can be carried out for each of the backlight areas rather than the entire screen. In other words, the brightness of each area of the backlight is configured to be set by the maximum value of gray level included in the input image data in each area, i.e., by the maximum gray level value by area, rather than being set based on the maximum gray level value of a single entire screen of the input image data.

The areas of the backlight are not required to be maximally lighted when the maximum gray level value by area is less than the maximum value of the gray level that can be displayed on the display device, and the brightness of the areas of the backlight can be reduced (locally light-modulated) to a level at which a necessary and sufficient amount of light is obtained. Power consumption can be reduced by a commensurate amount when the brightness of the areas of the backlight is reduced.

In general, the maximum gray level by area (excluding special cases such as displaying a uniform gray level over an entire screen) of the input image data is often different by area. For example, the distribution of gray level of ordinary input image data of a natural image or the like is not uniform for the entire screen. It is usual that there are areas containing locally high gray level (i.e., the by-area maximum gray level is high) as well as areas composed of only low gray levels (i.e., the by-area maximum gray level is low).

In the case such input image data is to be displayed, it is effective for further reduction in power consumption to individually control (local light-modulation) the brightness of each area of the backlight in accordance with the characteristics (e.g., maximum gray level value) by area. For example, the relationship in which the by-area maximum gray level is equal to or less than the maximum gray level of a single entire screen constantly holds true between the by-area maximum gray level and maximum gray level of a single entire screen. For this reason, the value obtained via the local light-modulation scheme is lower than the value obtained via the overall light-modulation scheme when the brightness of a certain area of the backlight is determined. In other words, the power consumption of local light-modulation is less than the power consumption of overall light-modulation. That is to say, the effect of reduced power consumption of the display device can be enhanced by adopting local light-modulation in comparison with the case in which overall light-modulation is applied.

Local light-modulation also has the effect of reducing brightness and improving contrast when a black image is displayed on a liquid crystal display device, for example. The effect is due to the following reasons. In a liquid crystal display device, light that passes through the liquid crystal cannot constantly be completely blocked when an attempt is made to display a black screen, light leaks, and the brightness cannot be set to 0 (the phenomenon is sometimes referred to as blackness degradation). However, the brightness during black screen display is also reduced because the leakage of light is naturally reduced when the amount of light produced by the backlight is reduced. In other words, a blacker black image can be displayed without degradation in blackness, a lively display having bright gray levels and dark gray levels is made possible, and contrast is improved.

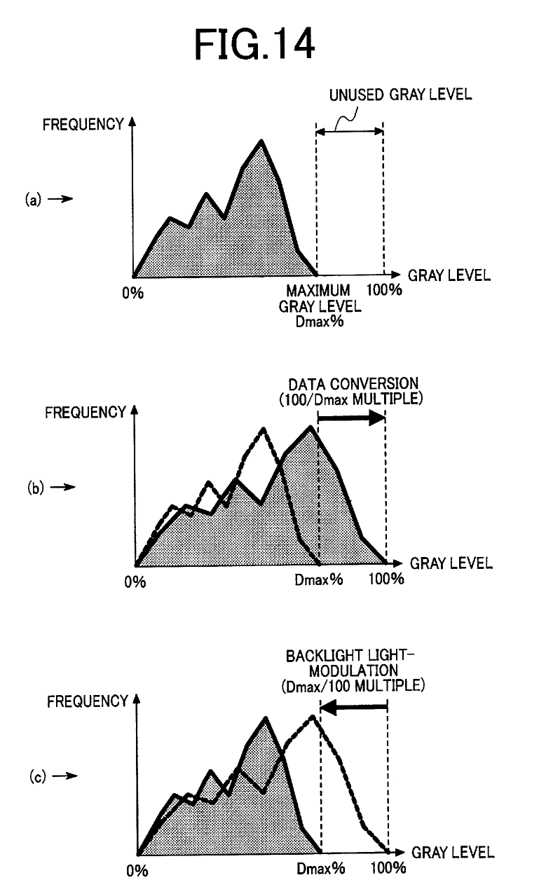

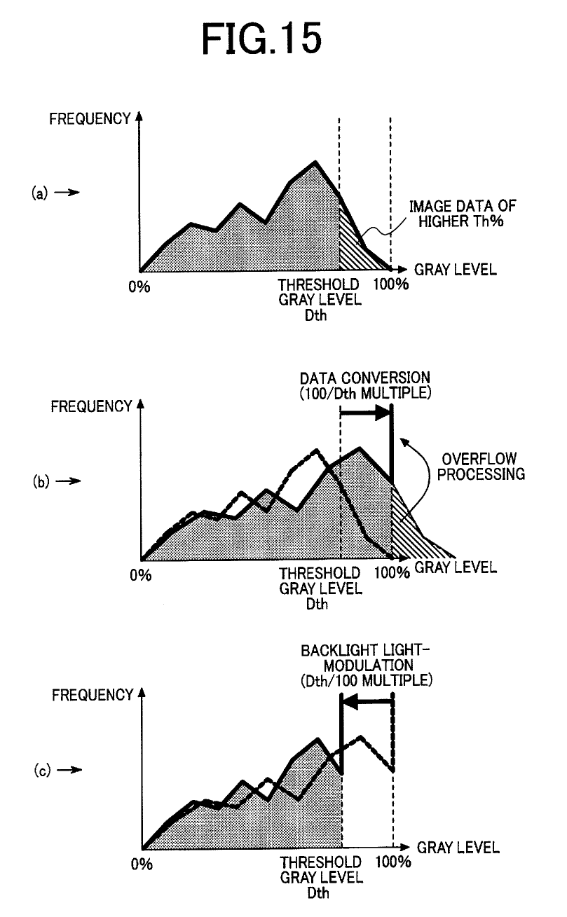

The concept and effect of local light-modulation of a backlight in a display device of the embodiments of the present invention was described above. In the description up to this point, the maximum gray level value as the characteristic of the input image data was used as an example, but the characteristic of the image used in local light-modulation is not limited to the maximum gray level value. Next, an example of the local light-modulation scheme will be described in detail with reference to FIGS. 14 and 15.

FIG. 14 is a diagram describing local light-modulation for gray level reproduction, and is an example of the backlight local light-modulation scheme in the display device of an embodiment of the present invention. (a) shows an example of the gray level frequency distribution in a certain area of the input image data. Gray level is represented on the horizontal axis and the frequency (the number of pixels having the gray level) of each gray level is plotted on the vertical axis. In this case, the backlight for illuminating the area is lighted at 100% brightness. In the example of (a), Dmax % is the maximum value of gray level of the input image data in the area, wherein Dmax<100. That is to say, the gray level from Dmax % to 100% is unused gray level. For example, when such image data is inputted, data conversion multiplies the gray level of the input image data by 100/Dmax.

(b) is a gray level frequency distribution of image data that has undergone data conversion. The image is unnecessarily bright when the data is displayed unchanged, but the original brightness of the image data can be reproduced by adjusting the brightness (backlight light-modulation) of the backlight for illuminating the area. Specifically, the brightness of the backlight for illuminating the area is multiplied by Dmax/100. (c) is a gray level frequency distribution of the result of displaying the image data that has undergone the data conversion and the backlight light-modulation. The original input image data shown in (a) is reproduced by the processing described above. In this manner, the image displayed on the display device using a local light-modulation scheme for gray level reproduction can have the brightness of the area of the backlight reduced without changing the original input image data, and the power consumption of the backlight can be reduced. However, there is a problem in the local light-modulation scheme for gray level reproduction in that power consumption can be reduced for the case in which the maximum gray level Dmax of the input image data is less than 100%, whereas the effect of reducing power consumption cannot be obtained in the case that the maximum gray level Dmax is equal to 100%.

The local light-modulation scheme for gray level reproduction was described above with reference to FIG. 14 as an example of local light-modulation of the backlight in the display device of the embodiments of the present invention. Next, another example of local light-modulation of a backlight in a display device of the embodiments of the present invention will be described with reference to FIG. 15.

FIG. 15 is an example of a scheme for local light-modulation of the backlight in a display device of the embodiments of the present invention, is different from the local light-modulation scheme for gray level reproduction, and is a diagram for describing a power consumption-prioritized local light-modulation scheme. As used herein, the term “power consumption-prioritized local light-modulation scheme” is a scheme that is different than the local light-modulation scheme for gray level reproduction described above, and is used for obtaining an effect of reduced power consumption even when the maximum gray level Dmax is equal to 100%.

(a) is a diagram showing an example of the gray level frequency distribution in a certain area of the input image data. Gray level is represented on the horizontal axis and the frequency (the number of pixels having the gray level) of each gray level is plotted on the vertical axis. In this case, the backlight for illuminating the area is lighted at 100% brightness. In the example of (a), the maximum value of the gray level of the input image data in the area is 100%. As described above, a reduced power consumption effect cannot be obtained in such input image data using the local light-modulation scheme for gray level reproduction. In view of this fact, the loss (color discarding) of a small amount of gray level information is allowed and power consumption is reduced in the power consumption-prioritized local light-modulation scheme. For example, the level at which the loss of gray level information is allowed is set as the allowance threshold Th. The pixels in the area are aligned in descending order from the pixel having the highest gray level value, and Th % order pixels are searched from the top position in the frequency. For example, when the number of pixels in the area is 200 and Th=5, the Th % order pixel is the 10^{th} pixel (=200×Th/100=200×5÷100) from the top position. Next, the gray level of the pixel is set to be the threshold gray level Dth. The gray level of the input image data is multiplied by 100/Dth via data conversion. Gray level that exceeds 100% by the data conversion is subjected to overflow processing at a gray level of 100%, for example.

(b) is a gray level frequency distribution of image data that has undergone the data conversion. The image is unnecessarily bright when the data is displayed, but the original brightness of the image data can be substantially reproduced by adjusting the brightness (backlight light-modulation) of the backlight for illuminating the area. Specifically, the brightness of the backlight for illuminating the area is multiplied by Dth/100. (c) is a gray level frequency distribution of the result of displaying the image data that has undergone the data conversion and the backlight light-modulation. The original input image data shown in FIG. 15A is reproduced by the processing described above. However, the gray level of the pixels having a gray level greater than the threshold gray level Dth is uniformly Dth % in the input image data. In other words, gray level information of pixels above Th % is lost in the power consumption-prioritized local light-modulation scheme, but power consumption can be reduced even in input image data for which power consumption cannot be reduced in the local light-modulation scheme for gray level reproduction. The allowance threshold Th is suitably determined with consideration given to the tradeoff between the effect of reduced power consumption and the image degradation caused by a loss of gray level information. The power consumption-prioritized local light-modulation scheme is suitable for, e.g., mobile phones, and other applications in which low power consumption is very critical.

An example of a scheme for local light-modulation in a display device of the embodiments of the present invention was described above.

Next, a method for implementing the local light-modulation will be described using examples. In the description below, an example will mainly be described for the case in which the local light-modulation scheme for gray level reproduction is adopted as the local light-modulation scheme, but it is also possible to adopt the power consumption-prioritized local light-modulation scheme, or another scheme may be adopted.

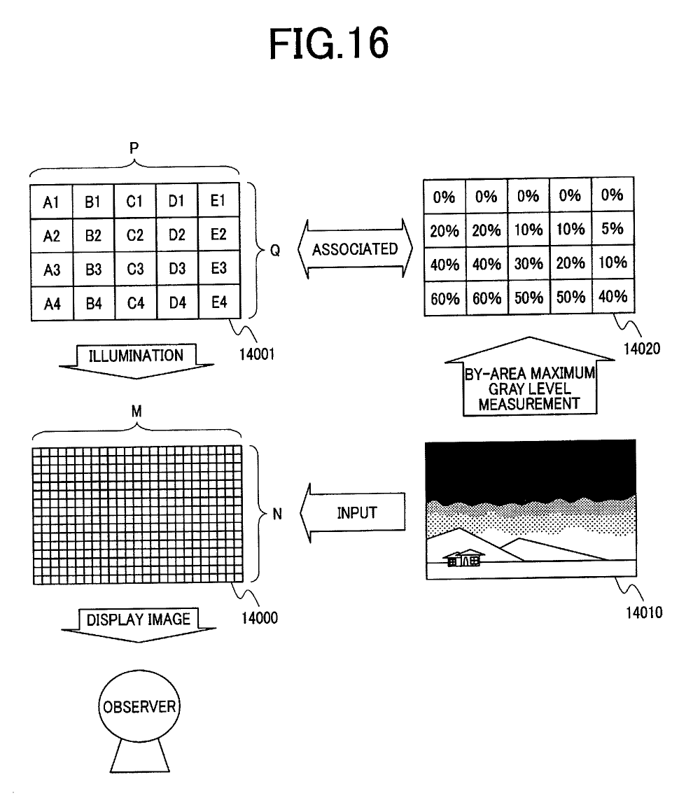

FIG. 16 is a diagram describing the concept of local light-modulation of the backlight in a display device of the embodiments of the present invention. In the diagram, reference numeral 14000 is a display panel and 14001 is a backlight. In relation to the backlight 14001, P=1 and Q=4 in the example in FIG. 2, and an example was shown for the case in which the areas are divided only in the vertical direction, but the example shown in FIG. 16 differs in that P=5, Q=4, and the areas are also divided in the horizontal direction. However, the number of divisions is an example, the number of divisions is not limited to these examples when applied to embodiments of the present invention, and another value may be used. Except for number of divisions, the display panel 14000 and the backlight 14001 are substantially the same as the configuration described with reference to FIG. 2 and a description is therefore omitted.

The reference numeral 14010 shows an example of input image data that is inputted to the display panel. Here, an example is shown of an image that gradually becomes darker from the lower portion of the screen to the upper portion such as a landscape picture taken of the sky during a sunset.

In the display device of the embodiments of the present invention, the maximum gray level in the areas of such an image is measured for each area of the input image data in which each area of the backlight manages the illumination. In the present display device, the by-area maximum gray level and the maximum gray level overall are measured from the input image data.

The by-area maximum gray level 14020 is an example of the result of measuring the by-area maximum gray level of the input image data in the image data 14010, shown as a ratio for the case in which the maximum gray level that can be displayed on the display device has been set to 100%. Hereinbelow in the present specification, the expression of the gray level value will be denoted as a ratio in relation to the maximum gray level that can be displayed on the display device.

For example, the by-area maximum gray level of area A1 is 0%, and the by-area maximum gray levels of area A2, area A3, and area A4 are 20%, 40%, and 60% (equivalent values), respectively, as shown in FIG. 16.

The by-area maximum gray level is measured and associated with each area of the backlight, and the number of measured areas is P×Q areas, which is the same as the number of divided areas of the backlight.

The overall maximum gray level (not shown) is the maximum value among the plurality of by-area maximum gray levels 14020. In the example of FIG. 16, the 60% of areas A4 and B4 is the overall maximum gray level.

For example, the brightness of the backlight of each area is adjusted to 60% on the basis of the value of the overall maximum gray level (60%) in the case that the overall light-modulation is applied to input image data such as that described above.

On the other hand, when local light-modulation is applied to similar input image data, the brightness of the backlight of area A1 is set to 0%, for example, and the brightness of the backlight of area A2, area A3, and area A4 are similarly adjusted to 20%, 40%, and 60%. As described above, the amount of light of the backlight can be controlled in small increments using local light-modulation, and the power consumption of the backlight and consequently the display device as well can be reduced as a result.

Here, the case in which the local light-modulation is applied to a display device provided with a function for intermittently lighting a backlight as described in examples 1 through 4 will be considered.

The simplest implementation method for incorporating local light-modulation in a display device provided with an intermittent lighting function is a configuration that allows the lighting period of the intermittent lighting described above to be modified for each area.

However, in the configuration described above, there is a deficiency in that the image quality becomes degraded when a moving image is displayed. The reason for this degradation is that the amount of moving image blur is different for each area.

The mechanism of the deficiency is described below. As described above, the amount of moving image blur is reduced as the lighting period is shortened in intermittent lighting. In other words, in areas having a lighting ratio of 20% and in areas having a lighting ratio of 40%, for example, moving image blur is reduced in areas having a lighting ratio of 20%. However, this phenomenon is not preferred when area A2 having a lighting ratio of 20% and area A3 having a lighting ratio of 40% are adjacent to each other as in the example shown in FIG. 16. This is due to the fact that a deficiency (degradation of image quality) occurs in that a step in the outline of the object is perceived at the border between area A2 and area A3 for the case in which the moving object has a size that straddles the areas A2 and A3, for example, because the magnitude of the moving image blur is different in each area. Hereinbelow, the example of the above-described deficiency will be referred to as “area step” in the present specification.

In example 5 of the present invention, a display device is provided in which the area step does not occur even when intermittent lighting and local light-modulation are used in combination.

As described above, the cause of an area step is that amount of moving image blur is different in each area. Therefore, the amount of moving image blur in each area can be made to be the same in order to solve the deficiency. In other words, the display device can be configured so that the lighting period has the same value in all of the areas even in the case that intermittent lighting and local light-modulation are used in combination.

An example of the operation of a display device of the embodiments of the present invention will be described below in which the lighting period in all areas are set to the same value in a display device provided with intermittent lighting and local light-modulation.

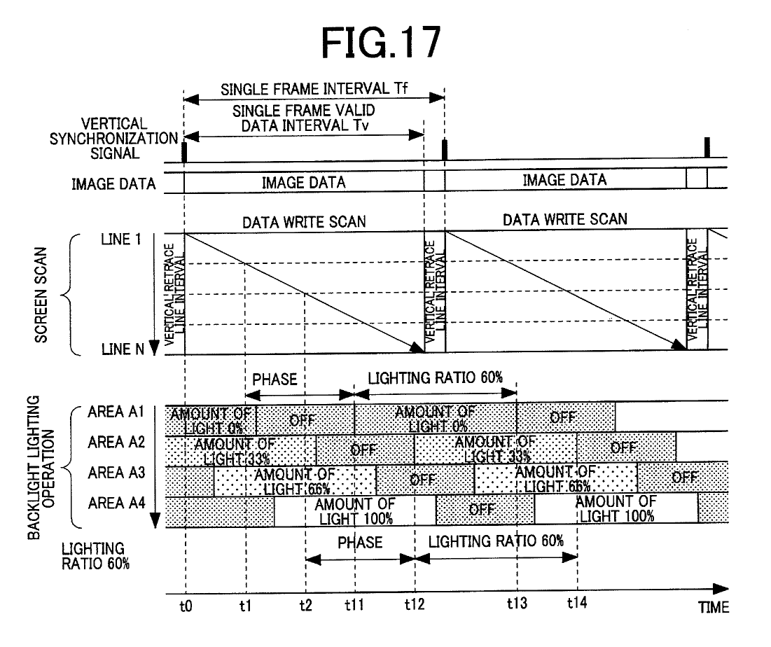

FIG. 17 is an example of a timing chart showing the operation of a display device in which the fifth example of the present invention has been applied. An example is shown of the temporal relationship between the screen scan of the display panel and the lighting operation of the backlight in relation to the input signal of the display device. Since the example is substantially the same as that shown in FIG. 6, a description of the shared parts is omitted and only the differing points will be described.

The display device of example 5 is different from the other examples described above on the point that the amount of light per unit of time of the backlight in the lighting period is individually controlled for each area, with the exception that the lighting ratio (i.e., the lighting period) is the same in each area of the backlight.

As described above, the display device of the embodiments of the present invention is provided with an intermittent lighting function. The data of the line groups of the display panel that correspond to each area of the backlight is written, and the display elements, which are the pixels of the lines, are thereafter made to wait a predetermined length of time until a sufficient response is made, whereupon the backlight is switched on.

The areas A1, A2, A3, and A4 shown in FIG. 17 correspond to the areas of the backlight shown in FIG. 16 and show the state of the lighting operation of each area. The frame starts at the time t0 in the example of FIG. 17 and the display panel is sequentially scanned from line 1. The scan of the lines corresponding to area A1 of the backlight is ended at the time t1, and the scan of the lines corresponding to area A2 of the backlight is ended at the time t2. Scanning is thereafter continued in the same manner until line N is reached.

The backlight of area A1 is switched on at the time t11, which is the time specified by the phase that has elapsed from time t1, and is switched off at the time t13, which is the lighting period specified by the lighting ratio that has elapsed from time t11. In a similar fashion, the backlight of area A2 is switched on at the time t12, which is the time specified by the phase that has elapsed from time t2, and is switched off at the time t14, which is the lighting period specified by the lighting ratio that has elapsed from time t12. The switching on and off operation is thereafter continued in the same manner until area A4 is reached.

As described above, the lighting ratio must be set to the same value in all of the areas in order to prevent the occurrence of a gray level step. However, such a setting is insufficient to implement brightness control for each area (i.e., local light-modulation) because the brightness of all of the areas is the same. To overcome this situation, the fact is utilized that the brightness of the backlight is the sum of the lighting period and the amount of light per unit of time. The brightness increases when the amount of light per unit of time increases, even when the lighting period is the same, and the brightness is conversely reduced when the amount of light per unit of time is reduced. In other words, the lighting period is kept the same and brightness can be controlled for each area when the amount of light per unit of time is controlled for each area. That is to say, it is possible to obtain the two effects of improved video performance via intermittent lighting and reduced power consumption by local light-modulation while preventing the occurrence of a area step.

Here, the lighting ratio is shared for the entire backlight as described above. Accordingly, the setting of the lighting ratio must be determined with consideration given to the characteristics of an entire single screen of input image data. Specifically, it is preferred that use is made of the maximum gray level value of an entire single screen of input image data. Control is carried out so that the lighting ratio is reduced as the maximum gray level of an entire single screen is reduced. For example, in the input display data 14010 shown in FIG. 16, the lighting ratio of area A1 through area A4 is the same for all at 60% because the maximum gray level of an entire single screen is 60%. Therefore, the lighting period is the same.

On the other hand, the amount of light per unit of time in the lighting period is made to be different for each area. Here, the amount of light per unit of time set for each area must be determined with consideration given to the characteristics of the image data included in the corresponding area among the input image data in addition to the characteristics of the entire single screen. Specifically, it is preferred that use be made of the maximum gray level value for each of the input image data. Control is carried out so that the amount of light per unit of time is reduced as the maximum gray level value of each area is reduced.

The amount of light per unit of time of each area is calculated from the lighting ratio and the target value of the backlight brightness of each area measured from the input image data. For example, the amount of light per unit of time can be calculated using the formula: target brightness value÷lighting ratio. Here, the target brightness value is obtained from, e.g., the by-area maximum gray level value. The lighting ratio is obtained from, e.g., the maximum gray level value of the entire single screen as described above.

For example, in the input display data 14010 shown in FIG. 16, the by-area maximum gray level value is 0% in area A1, the by-area maximum gray levels of area A2, area A3, and area A4 are 20%, 40%, and 60%, respectively. Also, the maximum gray level of the entire single screen is 60%.

In view of the above, the amount of light per unit of time of the backlight of area A1 is set to 0% when the input display data 14010 shown in FIG. 16 is displayed, for example. This is due to the fact that the by-area maximum gray level value of area A1 is 0%, the maximum gray level of the entire single screen is 60%, and therefore 0%÷60%=0%. Similarly, the amount of light of area A2, area A3, and area A4 is 33% (=20%÷60%), 66% (=40%÷60%), and 100% (=60%÷60%), respectively.

In this case, the lighting ratio of the area A1 is 60% and the amount of light per unit of time is 0%. Therefore, the ultimate brightness of the backlight is 60%×0%=0%. Similarly, the brightness of the backlight of area A2 is 60%×33%=30%, the brightness of the backlight of area A3 is 60%×66%=40%, and the brightness of the backlight of area A4 is 60%×100%=60%. In this manner, the brightness value of the backlight for each area shown by the example of FIG. 16 can be expressed by controlling both the lighting ratio and the amount of light per unit of time.

The operation of the display device of the embodiments of the present invention was described above. In this manner, the display device of the embodiments of the present invention has a lighting ratio (i.e., lighting period) that is shared in each area of the backlight, and operates so that an area step is not generated even when intermittent lighting and local light-modulation are used in combination by individually controlling the amount of light per unit of time for each area of the backlight in the lighting period.

Next, an example of a method for configuring a display device in which the fifth example of the present invention is applied will be described.

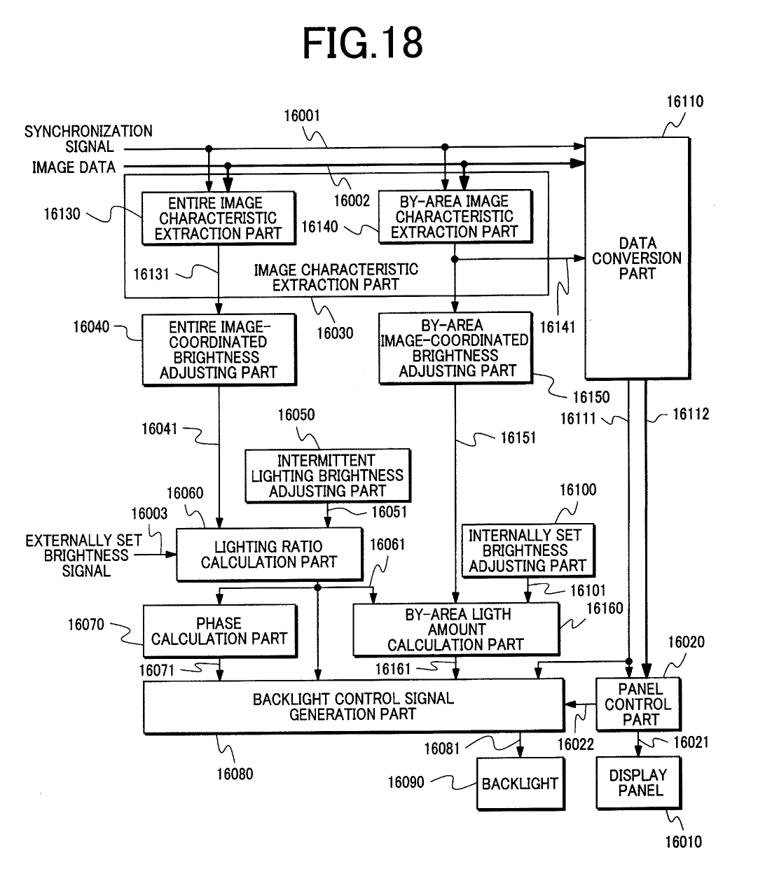

FIG. 18 is a diagram showing the configuration of the display device in which the fifth example of the present invention has been applied. Since the example is substantially the same as example 3 shown in FIG. 12, a description of the shared parts is omitted and only the differing points will be described.

In comparison with the example shown in FIG. 12, the main points of difference are that an entire image characteristic extraction part 16130 and a by-area image characteristic extraction part 16140 are provided to the image characteristic extraction part 16030, and further provided are an entire image-coordinated brightness adjusting part 16040, a by-area image-coordinated brightness adjusting part 16150, and a by-area light amount calculating part 16160.

The entire image characteristic extraction part 16130 extracts an entire image characteristic value 16131 of the screen from the entire image of a single screen (single frame) of the input image data 16002. For example, the maximum value of the gray level included in an entire single screen can be used as described above as the entire image characteristic value 16131. The entire image-coordinated brightness adjusting part 16040 calculates a lighting ratio 16041 for entire image-coordinated brightness adjustment, which is used for adjusting the brightness of the backlight 16090, from the entire image characteristic value 16131 extracted in the entire image characteristic extraction part 16130.

A lighting ratio calculation part 16060 comprehensively calculates the brightness required by the backlight 16090 from the lighting ratio 16041 for adjusting the entire image-coordinated brightness, the lighting ratio 16051 for driving the backlight with intermittent lighting, and the externally set brightness signal 16003, and calculates a combined lighting ratio 16061, which serves as a reference, for lighting the backlight 16090 in order to obtain the above-mentioned brightness. A phase calculation part 16070 calculates an optimal phase 16071 of the backlight 16090 from the combined lighting ratio 16061, and outputs the optimal phase. Characteristics information such as the example shown in FIG. 5 is used for calculating the optimal phase 16071.

A by-area image characteristic extraction part 16410 divides the image of a single screen (single frame) of the input image data 16002 into a plurality of areas, and extracts the characteristic value of the image included in an area for each of the areas. The characteristic value is furthermore outputted as a by-area image characteristic value 16141. Here, it is preferred that the areas be associated with the areas of the backlight divided into a plurality of areas. The maximum value of gray level included in the area of the image data can be used as the by-area image characteristic value 16141, for example.

The by-area image-coordinated brightness adjusting part 16150 calculates a lighting ratio 16151 for by-area image-coordinated brightness adjustment, which is used for adjusting the brightness of the backlight 16090 for each area, from the by-area image characteristic value 16141 extracted in the by-area image characteristic extraction part 16410. For example, the maximum value of the gray level included in an entire single screen can be used as described above as the entire image characteristic value 16131.

The by-area light amount calculating part 16160 calculates the amount of light 16161 per unit of time for each area with respect to each area of the backlight 16090 from the combined lighting ratio 16061, a lighting ratio 16151 for by-area image-coordinated brightness adjustment, and internally set brightness adjustment information 16101. The calculation of the amount of light 16161 per unit of time for each area is carried out based on a method such as that described above with reference to FIGS. 16 and 17, for example.

A backlight control signal generation part 16080 generates and outputs a backlight control signal 16090 for controlling for each area the brightness of the backlight 16090 from the combined lighting ratio 16061, an optimal phase 16071, an amount of light 16161 per unit of time for each area, a synchronization signal 16111, and write line information 16022.

The backlight control signal 16090 is configured so as to wait for a length of time specified by the optimal phase 16071 from the time at which the line writing belonging to a certain backlight area has ended, switch on the backlight area thereafter, and then switch off the backlight area after the backlight area is lighted for the period of time specified by the combined lighting ratio 16061. The backlight control signal 16090 is furthermore configured so that the areas of the backlights 16090 emit an amount of light specified by the light amount 16161 per unit of time for each area.

A configuration example of a display device to which an embodiment of the present invention has been applied was described above. Described next using an example is a method for driving a backlight for adjusting for each area the amount of light of the backlight per unit of time described above.

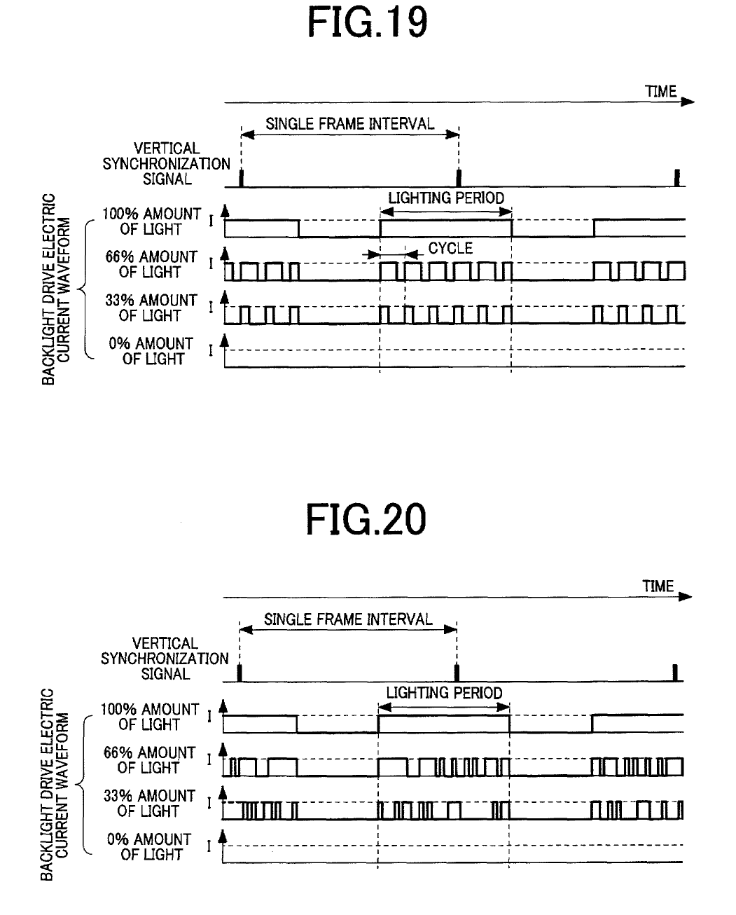

FIG. 19 is a timing chart showing an example of a method for driving a backlight for adjusting for each area the amount of light of the backlight per unit of time. Here, an example is considered for the case in which the input signal of the display device is considered using a vertical synchronization signal as a typical signal and in which, e.g., an LED is used as a light-emitting element constituting the backlight. An LED is a light-emitting element that emits light when electric current is allowed to flow, and the amount of emitted light, i.e., the brightness can be adjusted by adjusting the length of the time in which the electric current is allowed to flow as described above (a PWM scheme), even if the electric current value is constant.

FIG. 19 shows an example of the temporal relationship between the electric current waveform for driving the backlight and the input signal of the display device. The elapse of time is shown on the horizontal axis. The voltage value is shown on the vertical axis of the vertical synchronization signal, and the electric current value is shown on the vertical axis of the electric current waveform for driving the backlight. Shown in FIG. 19 is an example of a method for adjusting the brightness in a backlight configured so that electric current having an electric current value I is allowed to flow when the backlight is made to emit light and the electric current value when the backlight is turned off is 0. The lighting ratio obtained from the maximum gray level of an entire single screen is set to 60%. In this case, the backlight is lighted during an interval that corresponds to 60% of a single frame interval, for example, following the control method of intermittent lighting described above. This level is shared in all areas regardless of the by-area maximum gray level value. In this case, when the amount of light per unit of time that is desired is 100%, the waveform for driving the backlight is obtained by additionally allowing an electric current I to flow for a length of time that corresponds to 100% of the lighting period. In other words, the electric current I is allowed to flow for the entire lighting period. Alternatively, when the amount of light per unit of time that is desired is 0%, the waveform for driving the backlight is obtained by additionally allowing an electric current I to flow for a length of time that corresponds to 0% of the lighting period. In other words, the electric current I is not allowed to flow during the lighting period. In another option, when the amount of light per unit of time that is desired is, e.g., 66%, the waveform for driving the backlight is obtained by additionally allowing an electric current I to flow for a length of time that corresponds to 66% of the lighting period. In order to implement the present control, it is possible of use a configuration, for example, in which a cycle that will be used as a reference for switching on and off is provided, a basic waveform is formed that lights the backlight for a fixed ratio (66%, in this case) of the cycle, and the basic waveform is thereafter repeated in accordance with the cycle. In a similar fashion, when the amount of light per unit of time that is desired is, e.g., 33%, an electric current I is additionally allowed to flow for a length of time that corresponds to 33% of the lighting period. This scheme can also be used when other values are used as the amount of light per unit of time.

FIG. 20 is a timing chart showing an example that is different from FIG. 19 and is a method for driving a backlight for adjusting in each area the amount of light of the backlight per unit of time.

Since the example of the driving method is substantially the same as that shown in FIG. 19, a description of the shared parts is omitted and only the differing points will be described. In the example of FIG. 19, a method was described in which a basic waveform is repeated at predetermined cycles when the amount of light is adjusted, but in the example of FIG. 20, the point of difference is that the configuration is not provided with a basic cycle and switching on and off is carried out randomly. However, in this case as well, when the amount of light per unit of time that is desired is, e.g., 66%, the total lighting time in which random lighting is performed (electric current I is allowed to flow) is configured so as to correspond to 66% of the light period. In a similar fashion, when the amount of light per unit of time that is desired is, e.g., 33%, the total lighting time in which random lighting is performed (electric current I is allowed to flow) is configured so as to correspond to 33% of the light time. This scheme can also be used when other values are used as the amount of light per unit of time. Performing control in this manner allows the expectation that an effect can be obtained in which each backlight area is prevented from switching on and off altogether at the same time, the times at which electric current is allowed to flow are dispersed, and a momentary flow of a large amount of electric current to the circuits is prevented; and that an effect can be obtained in which the frequency spectrum of electromagnetic noise is dispersed.

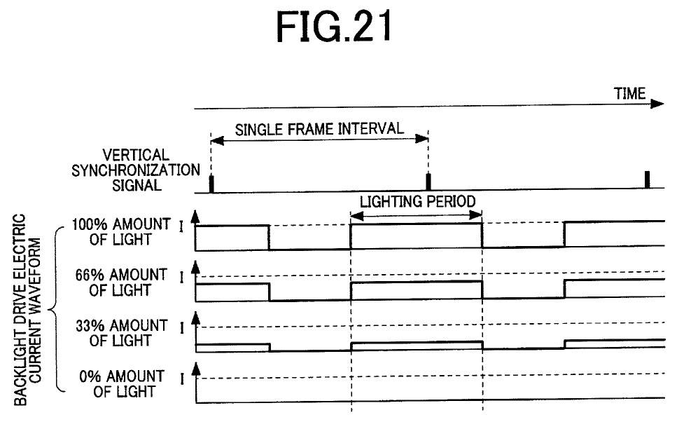

FIG. 21 is a timing chart showing an example that is different from FIGS. 19 and 20, and is a method for driving a backlight for adjusting in each area the amount of light of the backlight per unit of time. Since the example of the driving method is substantially the same as that shown in FIG. 19, a description of the shared parts is omitted and only the differing points will be described. In the example of FIG. 19, a PWM scheme for adjusting the amount of light of the backlight was described in which the length of time that the electric current is allowed to flow is adjusted while keeping the electric current value I constant when the backlight is lighted. In the example of FIG. 21, the point of difference is that an electric current light-modulation scheme is adopted for adjusting the amount of light of the backlight by adjusting the electric current value while keeping constant the time in which the electric current is allowed to flow. In this case, when the amount of light per unit of time that is desired is 100%, the waveform for driving the backlight is obtained by additionally allowing an electric current I to flow for the duration of the lighting period. Alternatively, when the amount of light per unit of time that is desired is, e.g., 0%, the waveform for driving the backlight is obtained by additionally allowing an electric current that corresponds to 0% of the electric current I to flow for the duration of the lighting period. In other words, electric current is not allowed to flow for the duration of the light period. Also, when the amount of light per unit of time that is desired is, e.g., 66%, the waveform for driving the backlight is obtained by additionally allowing an electric current that corresponds to 66% of the electric current I to flow for the duration of the lighting period. In a similar fashion, when the amount of light per unit of time that is desired is, e.g., 33%, an electric current that corresponds to 33% of the electric current I is allowed to flow for the duration of the lighting period. This scheme can also be used when other values are used as the amount of light. Here, the linear characteristics of amount of light emission and the amount electric current in the light-emitting elements are assumed to be present in order to simplify the description. In the case that the relationship between the amount of light emission and the amount of electric current of the light-emitting elements is not linear, the electric current value must be selected so that a suitable amount of light is obtained.

In accordance with the display device of the examples of the present invention as described above, there is a provided a function for driving a backlight with intermittent lighting with the aim of improving moving image blur. In the case that the lighting ratio is made to fluctuate in accordance with the content or the like of the image data, moving image blur can be reduced by suitably adjusting the phase and constantly lighting the backlight with an optimal phase that corresponds to the lighting ratio. It is also possible to obtain good display quality without generating an area step when this function is used in combination with local light-modulation control for controlling brightness by area of the backlight in accordance with the content or the like of the image data with the aim of reducing power consumption or obtaining other effects.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A display device having a display panel arrayed with a plurality of pixels, and a backlight for illuminating the display panel, wherein image data is received as input and displayed on the display panel comprising:
a lighting drive circuit for switching on and off the backlight at least one or more times within a single frame interval of the image data;
a circuit for switching on the backlight after a predetermined standby time has elapsed after updating of the display data in an area illuminated by the backlight of the display panel, and switching off the backlight after a lighting period of the backlight, which is variable, has elapsed; and
a circuit for adjusting the predetermined standby time in accordance with the length of the lighting period of the backlight.

2. A display device according to claim 1 comprising:
a circuit for extracting characteristics of the image data; and
a circuit for adjusting the length of the lighting period of the backlight in accordance with the characteristics of the image data.

3. A display device according to claim 2 comprising:
a data converting circuit for converting the image data in accordance with the characteristics of the image data extracted in the circuit for extracting the characteristics of the image data; and
a circuit for displaying the converted image data on the display panel.

4. A display device according to claim 1 comprising:
a circuit for receiving as input an externally set brightness signal for adjusting the brightness of the backlight from an external device; and
a circuit for adjusting the length of the lighting period of the backlight in accordance with the externally set brightness signal.

5. A display device according to claim 4 comprising:
a data converting circuit for converting the image data in accordance with the externally set brightness signal; and
a circuit for displaying the image data on the display panel.

6. A display device according to claim 1 comprising:
a circuit for switching on and off the backlight over a further plurality of cycles within the lighting period of the backlight; and
a circuit for adjusting the brightness of the backlight by the switching on and off the backlight.

7. A display device according to claim 1 comprising:
a circuit for adjusting the brightness of the backlight in accordance with brightness information of the image data; and
a circuit for controlling so that the lighting period of the backlight in the lighting drive circuit is shortened as the brightness of the backlight is reduced.

8. A display device having a display panel arrayed with a plurality of pixels, and a backlight for illuminating the display panel, wherein image data is received as input and displayed on the display panel comprising:
a lighting drive circuit of a backlight for switching on and off the backlight at least one or more times within a single frame interval of the image data;
a circuit for switching on the backlight after a predetermined standby time has elapsed after updating of the display data in an area illuminated by the backlight of the display panel, and switching off the backlight after the lighting period has elapsed;
a circuit for adjusting the predetermined standby time in accordance with the length of the lighting period of the backlight, which is variable; and
a circuit for receiving as input brightness information adjusted by the characteristics of the image data, the externally set brightness signal set by an external device or a combination of the two, and for adjusting the length of the lighting period of the backlight in accordance with the brightness information.

9. A display device according to claim 8 comprising a circuit for controlling so that the lighting period of the backlight is shortened in the lighting drive circuit as the brightness of the backlight is reduced according to the brightness information.

10. A display device having a display panel arrayed with a plurality of pixels, a backlight for illuminating the display panel, and a drive circuit for displaying on the display panel image data received as input; wherein
the backlight has a circuit configuration in which the interval that starts when the image data is written to the pixels and ends when the backlight starts to light varies in accordance with a length of a lighting period of the backlight within a single frame time.

11. A display device having a display panel arrayed with a plurality of pixels, and a backlight for illuminating the display panel, wherein image data is received as input and displayed on the display panel comprising:
a plurality of backlight areas that constitute the backlight; and
a lighting drive circuit in which the backlight areas are associated so as to illuminate the plurality of pixels of the display panel, the backlight areas within a single frame time of the image data can be switched on and off at least one time or more, the lighting periods of each of the backlight areas can be varied, the backlight areas are switched on after a predetermined standby time has elapsed after the display data of the plurality of pixels illuminated by the backlight areas has been updated, the backlight areas are switched off after the lighting periods has elapsed, the predetermined standby time is adjusted in accordance with the length of the lighting periods of the backlight areas, and the amount of light emitted per unit of time in a lighting period can be varied, wherein:
the lighting drive circuit comprises a circuit for extracting characteristics of an entire single frame of the image data and a circuit for extracting for each backlight area the characteristics of a plurality of pixels for illuminating the backlight areas of image data;
the length of the lighting period of the backlight is adjusted in accordance with the characteristics of the entire single frame of the image data; and
the amount of light emitted per unit of time in the lighting period is adjusted in accordance with the characteristics of the plurality of pixels illuminated by the backlight and the characteristics of the entire single frame of the image data for each area of the backlight.

12. A display device according to claim 11 wherein the characteristic of the entire single frame of the image data is the maximum value of the gray levels of the image data included in the single frame.

13. A display device according to claim 11 wherein the characteristic of the plurality of pixels illuminated by the backlight for each area of the backlight is the maximum value of the gray levels of the image data that corresponds to the plurality of pixels.

14. A display device according to claim 11 wherein the characteristic of the entire single frame of the image data is the frequency distribution of the gray levels of the image data included in the single frame.

15. A display device according to claim 11 wherein the characteristic of the plurality of pixels illuminated by the backlight for each area of the backlight is the frequency distribution of the gray levels of the image data that corresponds to the plurality of pixels.

16. A display device according to claim 1 comprising a circuit for carrying out data conversion so that the gray level frequency distribution of the image data extends to unused gray levels in the case that the unused gray levels are present in the gray level frequency distribution of the image data of a certain area, and adjusting the backlight brightness that corresponds to the area.

17. A display device according to claim 1 comprising a circuit for carrying out data conversion so that gray level frequency distribution of the image data exceeds a used gray level in the case that an unused gray level is not present in the gray level frequency distribution of the image data of a certain area, and adjusting the backlight brightness that corresponds to the area.

18. A display device according to claim 1 comprising:
a circuit for carrying out data conversion so that the gray level frequency distribution of the image data extends to unused gray levels in the case that the unused gray levels are present in the gray level frequency distribution of the image data of a certain area, and adjusting the backlight brightness that corresponds to the area; and
a circuit for carrying out data conversion so that gray level frequency distribution of the image data exceeds a used gray level in the case that an unused gray level is not present in the gray level frequency distribution of the image data of a certain area, and adjusting the backlight brightness that corresponds to the area.
